(19) United States
(12) Patent Application Publication
(10) Pub. No.: US 2026/0081897 A1
(43) Pub. Date: Mar. 19, 2026

(54) SYSTEMS AND METHODS FOR SENSITIVE DATA TRANSACTION ORCHESTRATION

(71) Applicant: Basis Theory, Inc., Mill Valley, CA (US)

(72) Inventors: Colin Luce, Mill Valley, CA (US); Casey Clegg, Redwood City, CA (US); Davi Aquino, Paraná (BR); James Armstead, Madrid, IA (US); Drew Hudec, Mentor, OH (US); Lucas Chociay, Paraná (BR); Kevin Peraza, Heredia (CR); Brian Gonzalez, Denver, CO (US); Josue Sarkis, San Jose (CR); Robert Greathouse, Des Moines, IA (US); Matthew Trisoline, Prospect, PA (US)

(21) Appl. No.: 19/329,486

(22) Filed: Sep. 15, 2025

Related U.S. Application Data
(60) Provisional application No. 63/694,777, filed on Sep. 13, 2024.

(51) Int. Cl. H04L 9/40

(52) U.S. Cl. CPC H04L 63/0428

(57) ABSTRACT

Systems and methods are described for securely processing transactions including the transfer of sensitive data. In some cases, a universal token representative of sensitive data may be generated by a transaction orchestration service, where the universal token includes one or more aliased data sets and metadata corresponding to the underlying sensitive data. In some cases, the aliased data sets include representations of the sensitive data without including the sensitive data. A transaction request that invokes the universal token may be received, and response to the request, an aliased data set may be retrieved from the universal token, where the aliased data set corresponds to the sensitive data to fulfill the transaction. The aliased data set or the universal token may then be set to a processing service to complete the transaction.

### CROSS-REFERENCE TO RELATED APPLICATIONS

This application claims the benefit of U.S. Provisional Patent Application No. 63/694,777, filed Sep. 13, 2024, entitled “SYSTEMS AND METHODS FOR SENSITIVE DATA TRANSACTION ORCHESTRATION,” the disclosure of which is herein incorporated in its entirety.

### BACKGROUND

The generation, processing and transfer of sensitive and other data, for use in various industries and for various purposes is greatly expanding. With the proliferation of cloud computing resources used by various parties, such as to complete a transaction or transfer sensitive data, the importance of data security, particularly coupled with efficient ways of accessing and transferring this data cannot be understated. Current data encryption techniques and other security measures, including compliance with various standards, such as Payment Card Industry Data Security Standard (PCI DSS), HIPAA, SOC 2, ISO-27001, etc., enable high levels of data security. However, it has been a significant challenge for businesses to store, process and transfer data efficiently while ensuring compliance with these security measures.

Accordingly, a need exists for better ways to access, store, and transfer data, particularly sensitive data, in an efficient manner while ensuring compliance with the security standards. Particular systems where this need exists includes transaction orchestration systems, vault or storage systems of this sensitive data, and techniques for transacting across multiple transaction providers. Currently, these systems provide a rigid and black-box approach to reducing the effects of Payment Card Security) (PCI) compliance on a Merchant or Service provider and create a single point of failure, restrictions on data usage, and lock-in to a single provider to provide these multi-provider transactions.

### BRIEF DESCRIPTION OF THE DRAWINGS

Various techniques will be described with reference to the drawings, in which:

FIG. 1 illustrates an example of a transaction orchestration system, according to at least one embodiment;

FIG. 2 illustrates an example process for collecting sensitive data, such as credit card or other transaction data, which may be performed by the storage coordinator of FIG. 1, according to at least one embodiment;

FIG. 3 illustrates an example process for storing sensitive data, such as credit card or other transaction data, which may be performed by the storage coordinator of FIG. 1, according to at least one embodiment;

FIG. 4 illustrates an example process reconciliating sensitive data, such as credit card or other transaction data, which may be performed by the aliased card coordinator of FIG. 1, according to at least one embodiment;

FIG. 5 illustrates an example process converting sensitive data, such as credit card or other transaction data, which may be performed by the aliased card coordinator of FIG. 1, according to at least one embodiment;

FIG. 6 illustrates another example process for converting sensitive data, such as credit card or other transaction data, which may be performed by the aliased card coordinator of FIG. 1, according to at least one embodiment;

FIG. 7 illustrates an example process for lifecycle management of sensitive data, such as credit card or other transaction data, which may be performed by the aliased card coordinator of FIG. 1, according to at least one embodiment;

FIG. 8 illustrates an example of a universal token, which may be utilized by the systems of FIGS. 1 and 2, according to at least one embodiment;

FIG. 9 illustrates a an example processes for configuring a connection for a transaction involving sensitive data, which may be performed by the transaction orchestrator of FIG. 1, according to at least one embodiment;

FIGS. 10 and 11 illustrate example processes for facilitating a transaction involving sensitive data, which may be performed by the transaction orchestrator of FIG. 1, according to at least one embodiment;

FIG. 12 illustrates an example of a tokenized data system, which may interface with the transaction orchestration of FIG. 1, according to at least one embodiment;

FIG. 13 illustrates an example of interactions with a tokenized data system, such as the system of FIG. 12, according to at least one embodiment;

FIG. 14 illustrates an example of an outbound proxy, such as may be provided by the system of FIG. 12, according to at least one embodiment;

FIG. 15 illustrates an example of an inbound proxy, such as may be provided by the system of FIG. 12, according to at least one embodiment, according to at least one embodiment;

FIG. 16 illustrates example interactions with a reactor, such as may be performed using the system of FIG. 12, according to at least one embodiment;

FIG. 17 illustrates an example of a token data object, according to at least one embodiment; and

FIGS. 18 and 19 illustrate examples data structures and Application Programming Interfaces (APIs) that may be utilized by the system of FIG. 12.

### DETAILED DESCRIPTION

In various embodiments, systems and methods are described relating to storing, accessing, and using sensitive data. In various examples, the described systems and techniques may enable a transaction orchestrator for organizations without taking on any Payment Card Industry (PCI) requirements for handling or storing credit card or other similar requirements for handling other sensitive data. In various examples, this may be effectuated by one or more processes that ensure the sensitive data (e.g., credit card or other financial information) is protected. In various examples, the processes may be resilient from downtime. In some cases, the collection process of obtaining sensitive data may include collecting and storing the sensitive data (e.g., credit card data) in a centralized vault, which may be hosted by cloud computing resources, when a connection is capable of being made to the vault, such as over one or more network connections. When a suitable or secure connection to the vault is not available, the collection library will fall back to connect directly to a different vault or processing partner or service seamlessly, such as may be provided by backup systems, or other actors, devices, etc. that do have a suitable network connection.

In various aspects, the described systems and techniques may provide coordination of the lifecycle of aliased data (such as aliased credit card data), enabling direct processing from the client without the burden of managing lifecycles of the raw sensitive or card data and aliased data from other organizations or actors.

In various aspects, the described systems and techniques may include a client-side transaction orchestrator system that enables the utilization of aliased sensitive data (e.g., credit card or payment data) with its owner without the need to integrate directly with each vendor system. This may enable the creation of a unified client-side contract that may be used with any transaction organization regardless of the payment method or aliased data provided. In some aspects, the coordinator system may provide data and metric streams for all transaction-related data, such as may be used to aggregate and optimize the transaction orchestrator. In various examples, the optimizations may include but are not limited to, reductions in costs, latency, or increased orchestrator availability.

As used herein, a vendor may refer to an organization, service, system, or device that can accept customer data (e.g., credit card data) for various reasons (processing, analytics, etc.). A system user may refer to a system or device integrating with the described orchestration system. A merchant may refer to an organization, service, system, or device utilizing the collection process, storage coordinator, or transaction coordinator. A consumer may refer to a device that is utilizing the service provided by the merchant. A vault may refer to a centralized service, service, or device capable of storing regulated and compliant data (e.g., credit card data) on behalf of a merchant. Raw card data or raw sensitive data may refer to credit card data or other sensitive data, which may be highly regulated, that is to be stored within the vault. A vaulted card or vaulted sensitive data may refer to an identifier representing the raw card data within a centralized vault. An aliased card data/aliased token may refer to an identifier representing the raw card data within a vault or vendor. (e.g. also encompassing network tokens, processor tokens, privately owned vault tokens, format-preserving encryption (FPE) tokens, “vaultless” tokens, etc.). Connections may refer to pre-configured contracts to simplify the coordination of requests to and from a merchant, vendor, and/or vault system. Lifecycle events may refer to events that are handled by each aliased and raw card stored. These events include but are not limited to, creation, deletion, expiration, and/or automatic data updating (e.g. credit card account updater). Card metadata may refer to metadata about a card that does not fall under the scrutiny of PCI compliance (e.g. Name, Expiration, Address, Network/Scheme Transaction Id, MFA details (e.g. 3DS) etc.). In some cases, metadata may also refer to metadata about other sensitive data. A collection library may refer to a library that displays payment method collection forms, collects details, and sends them to a compliant third-party service or system while removing many compliance requirements. Payment method details may include data that relates to the cardholder that owns the raw card data. This data may contain billing address details, communication details (email, phone), name of the individual, and details about the raw card issuer, bank, network, and card (e.g. last 4, network, brand, etc.). It should be appreciated the terms defined above are only given by way of example, and that various other definitions of these terms may be applicable or inferred from this disclosure.

In some cases, the described techniques may include a computer-implemented method for securely storing, accessing, and processing sensitive data to facilitate transactions in a transaction orchestration system. The method may include receiving sensitive data from a user device via a storage coordinator, where the storage coordinator is configured to direct the sensitive data to one or more storage components of the transaction orchestration system. The storage coordinator or another entity may determine whether a secure connection is available to a centralized vault. When the secure connection is available, the sensitive data may be stored in the centralized vault. In some cases, the centralized vault is configured to securely manage raw sensitive data, aliased data, and lifecycle events of such data. However, in cases where a secure connection is unavailable, the orchestration system may dynamically redirecting the sensitive data through a collection library loader to an alternative collection library that interfaces with a secondary vault or processing partner, where the collection library loader is configured to identify and load the most suitable alternative collection library.

In some cases, the method may further include generating aliased data corresponding to the sensitive data, where the aliased data provides a tokenized identifier for the raw sensitive data stored within the centralized vault or alternative storage solution. In various examples, the aliased data may be used to facilitate transaction requests through a unified transaction orchestration library, where the unified transaction orchestration library is configured to: retrieve aliased data from the vault or collection library, compose and send transaction requests through pre-configured connection contracts to designated merchant or vendor endpoints, and receive transaction responses to process, validate, and relay to the requesting system.

In some examples, the described systems and techniques may additionally or alternatively include managing the lifecycle of the aliased data and the raw sensitive data, such as including handling updates, expirations, and deletion requests while ensuring synchronization of data across the centralized vault, aliased card coordinator, and third-party connections. In yet some examples, the described systems and techniques may additionally or alternatively include dynamically applying routing decisions for transaction requests using a rule-based decision engine. In various cases, the rule-based decision engine may include one or more of predefined rules to determine routing of requests based on transaction attributes, connection availability, or external data conditions, a fallback mechanism for routing to default connections in the absence of rule satisfaction or available connections, and/or maintaining performance metrics for all lifecycle and transaction events, wherein the metrics are used for optimizing system performance, reducing latency, enhancing availability, and providing analytics for improved transaction acceptance.

In the preceding and following description, various techniques are described. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

As one skilled in the art will appreciate in light of this disclosure, certain embodiments may be capable of achieving certain advantages, including some or all of the following: (1) increased data security by limiting exposure of sensitive data to external systems for the storage, transfer and processing of sensitive data, (2), reduced latency in the storage, transfer and processing of sensitive data, and (3) various other advantages as will be described and made apparent throughout the rest of the disclosure.

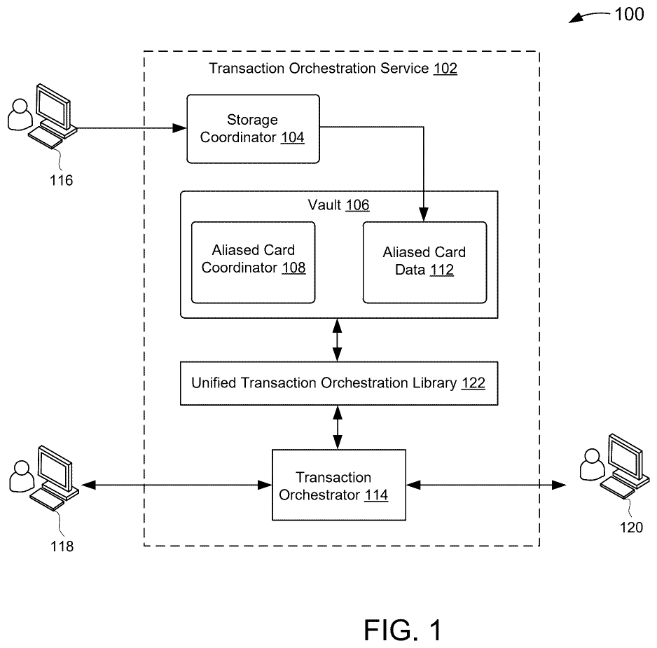

FIG. 1 illustrates an example diagram 100 of a transaction orchestration system or service 102 interacting with various users through user/computing devices 116, 118, 120. In the example illustrated, the transaction orchestration system or service 102 may include a number of components or processes, such as a storage coordinator 104, a vault 106, which may be provided by a data storage service, and may include or interface with an aliased card coordinator 108 to store, update, and interact with tokens 110 and/or aliased card data 112. In various examples, the transaction orchestration service 102 may also include a unified transaction orchestration library 122 and a transaction orchestrator 114. Each component or process will be described in greater detail below.

In some aspects, the transaction orchestration service 102, and the individual components or processes thereof, may be provided by or include various computing systems or devices, including physical computing devices, virtual or cloud-based computing devices, or a combination thereof. As described herein, the transaction orchestration service 102 may enable interactions with various types of sensitive data. As described herein, the primary example described herein is with respect to financial, credit card, or other payment type data. However, it should be appreciated that the described systems and techniques can similarly be applied to other sensitive data that is subject to various security standards, including HIPAA, and others.

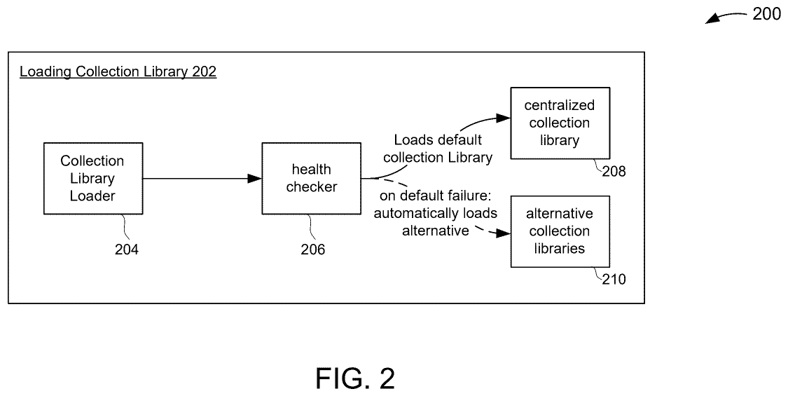

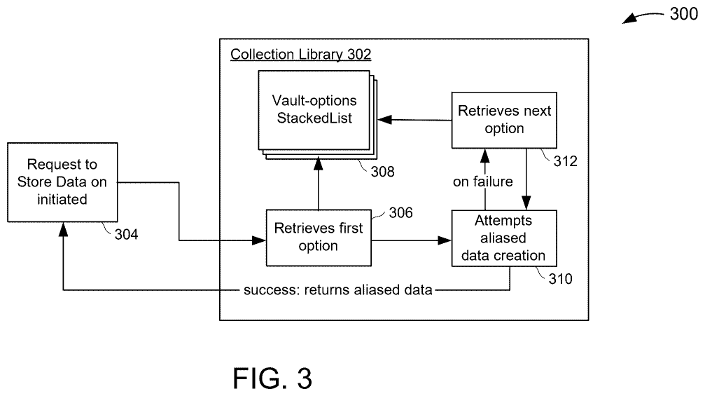

A user, such as customer, may interact with service 102 via user or consumer device 116 via one or more networks, such as to enter, update, or otherwise interact with various sensitive data, such as payment information or credit card information, through a storage coordinator 104. The storage coordinator 104 may be a computerized process that collects and directs sensitive data obtained from or through the user device 116 to various components of the transaction orchestration service 102. In some cases, the storage coordinator may ensure that sensitive data (e.g., card data) entered by a user is collected and stored in such as way as to ensure data security, particularly in light of a lack of network connectivity to the primary data storage for securely storing sensitive data, such as where the vault 106 may not be accessible. In these cases, the storage coordinator 104 may interface with one or more collection libraries, such as via processes described in greater detail below in reference to FIGS. 2 and 3.

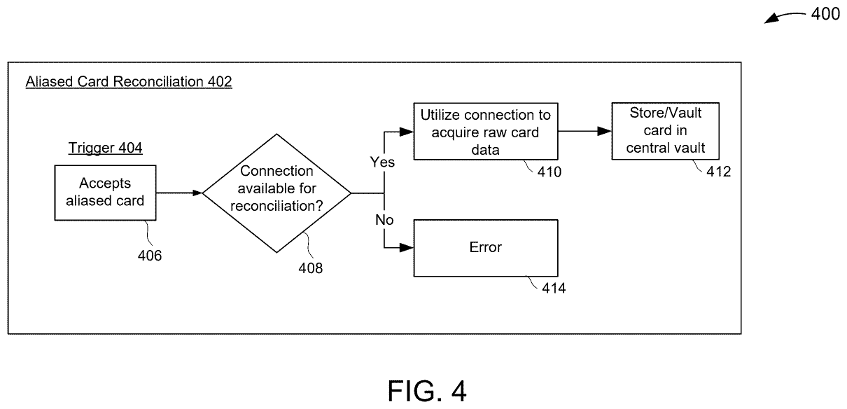

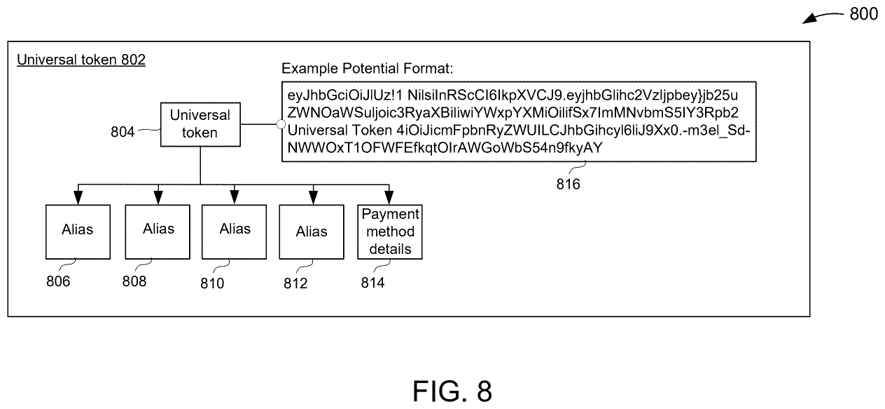

In various examples, the vault 106 may be a collection of one or more data storage devices, cloud computing resources, or data storage services that securely store and provide access to sensitive information, such as payment (e.g., card data) and other financial data. In various examples, the aliased card coordinator 108 may be a service, such as provided by the centralized vault 106 that coordinates the lifecycle of aliased and raw card data stored by and/or managed by the vault 106. In other examples, the aliased card coordinator 108 may be a service, such as provided by the transaction orchestrator 114, and utilized from a client device 116. When initiated with either an aliased card or raw card data, the aliased card coordinator 108 may convert the raw card data into vaulted card data, convert the aliased card data into the raw card data, create aliased card data at any configured connections, and manage all lifecycle events for any aliased data stored or generated by the aliased card coordinator 108, as described in greater detail below in reference to FIGS. 4-7. In some cases, some or all aliased card data may be added to a single alias wallet or collection, connecting aliases that identify the exact underlying raw card data and can be related to a consumer identifier, to better manage and link data received from different sources and at different times. In some cases, the alias wallet may take the form of or be stored in a data structure referred to as a universal token, such as universal token 802 described below in reference to FIG. 8.

In various cases, the transaction orchestration system 102 may also include a unified transaction orchestration library 122, which may enable the creation of client-side transaction orchestration services. The unified transaction orchestration library 122 can be generated and configured across any coding language and connected to HTTP/TCP services to facilitate payment transactions. This unified transaction orchestration library 122 may provide single contracts for services orchestrating payments (e.g., charge, void, payment intents, authorize, capture, tokenize, etc.). The unified transaction orchestration library 122 may expose a single entry point per service and expose any data that may be needed to further optimize an organization's payment acceptance strategy to be stored and analyzed. In various aspects, the transaction orchestration system 102 may include a transaction orchestrator 114, which may enable communications between one or more merchant devices 118 and/or vendor devices 120 involving aliased card data/tokens to facilitate various transactions, such as financial transactions, purchases, etc., such as using the unified transaction orchestration library 122. In various cases, the transaction orchestrator 114 may orchestrate the processes of payments between a vendor device, system, or service 118 and a merchant device, system, or service 120. In various cases, one or more of the unified transaction orchestration library 122 and the transaction orchestrator may reside with one or both of the vendor 118 or merchant 120 systems or devices, to enable payment processes when network connectivity is down or degraded.

FIG. 2 illustrates an example diagram 200 for collecting sensitive data, such as credit card or other transaction data, via a collection library loading process 202, which may be performed by the storage coordinator 104 of FIG. 1. In some cases, the storage coordinator 104 may interface with a collection library loader 204 to load the card data into an available collection library. In some cases, the collection library loader 204 may provide a collection library failover feature, such that if a connection to the primary centralized library (which may be provided by or interface with vault 106) cannot be established, the library will automatically attempt to failover to an alternative data collection option, to store the data into another secure library, such as a provided by a storage location having a network connection with the storage coordinator 104. In some cases, process 202 may provide robust and fault-tolerant loading of collection libraries to facilitate secure and efficient handling of sensitive data, such as payment information, even in scenarios where default libraries fail or are unavailable.

As illustrated in FIG. 2, process 202 begins with the collection library loader 204, which is responsible for initiating the loading of a collection library. The collection library loader 204 interfaces with a health checker 206, which evaluates the status and availability of the default collection library. The health checker 206 plays an important role in ensuring the reliability of the system by verifying the operational status of the default library before it is loaded.

In some cases, if the health checker 206 determines that the default collection library is healthy and operational, the health checker 206 may proceed to load the centralized collection library 208. The centralized collection library 208 serves as the primary repository for collecting and managing sensitive data, such as payment card information, and is designed to integrate seamlessly with the broader transaction orchestration system. The centralized collection library 208 ensures secure and efficient data handling, leveraging its centralized architecture to provide consistent and reliable service.

In cases where the health checker 206 detects a failure or unavailability of the default library (e.g., library 208 which may be an example of vault 106 described above), the system automatically transitions to an alternative collection library. In this case, the health checker 206 triggers the loading of one or more alternative collection libraries 210, which are pre-configured to serve as backups. The one or more alternative collection libraries 210 ensure that the system remains operational and capable of handling sensitive data, even in scenarios where the default library is inaccessible. This automatic fallback mechanism enhances the fault tolerance and resilience of the system.

The collection library loader 204, health checker 206, centralized collection library 208, and alternative collection libraries 210 work in concert to provide a robust and dynamic solution for managing collection libraries. In some cases, the health checker 206 interacts with both the centralized collection library 208 and the alternative collection libraries 210 multiple times throughout the process to ensure that the most appropriate library is loaded based on the current system status.

FIG. 3 illustrates an example process 300 for storing sensitive data, such as credit card or other transaction data, which may be performed by the storage coordinator 104 of FIG. 1. In some aspects, once data has been collected from a consumer (e.g., entering credit card details via consumer device 116), a coordination process 300 may be initiated to optimize the success of storing the data within one of the options selected/provided by the system user. In some aspects, process 300 may include creating aliased card data based on the request, and returning a notification of the success of the operation, along with, optionally, an identifier of the aliased card data that is stored, to enable retrieval of the aliased card data at another time. In various cases, process 300 may provide for efficient handling of data storage requests by dynamically interacting with a collection library and managing vault options to create aliased data.

As illustrated in FIG. 3, process 300 may begin with a request to store data 304 being received, such as by the storage coordinator 104 or transaction orchestration service 102 described above in reference to FIG. 1, from a user device or system seeking to securely store sensitive information. The request to store data 304 may be directed to the collection library 302, which serves as the central component for managing storage operations. The collection library 302 contains a vault-options stackedlist 308, which organizes available vault options for storing data securely.

Upon receiving the request to store data 304, the collection library 302 may retrieve the first available vault option from the vault-options stackedlist 308 via the retrieve first option 306 operation. If the selected vault option successfully processes the request, the system returns aliased data to the requester at operation 312, completing the process 300. In cases where the first vault option fails, the system transitions to the retrieves next option 312 operation, which dynamically selects the next available vault option from the vault-options stackedlist 308 to attempt the storage operation again. A next available vault option is selected iteratively until one is successful, at which point process 300 ends. In some cases, if storage coordinator 104 in performing process 300 encounters repeated failures, it may initiate the attempts aliased data creation 310 process. The attempts aliased data creation 310 operation is designed to generate aliased data directly, bypassing the vault options if necessary. This fallback mechanism ensures that sensitive data can still be securely stored and aliased, even in scenarios where all vault options are unavailable. In various cases, the collection library 302 serves as the central hub for coordinating these operations, dynamically managing vault options and aliased data creation to optimize storage reliability and security.

FIG. 4 illustrates a diagram 400 of an example process 402 for reconciliating sensitive data or aliased card data, such as credit card or other transaction data, which may be performed by the aliased card coordinator 108 of FIG. 1. In some aspects, it may be beneficial to reconcile various card data (or other sensitive information) that relate to the same card data, to facilitate better utilization of storage resources, quicker access to the underlying data for processing (e.g., performing a transaction with the data), and so on. In various cases, process 402 may be performed periodically. In some cases, process 402 may include verifying that there is a suitable connection to carry out the reconciliation process. In some cases, when an aliased card generated by another organization or vendor is provided to the aliased card coordinator 108, the aliased card coordinator 108 will attempt to reconcile the centralized vault (e.g., vault 106) by retrieving the raw data stored at the aliased data location within an organization, and comparing it to data stored by the vault 106. In some aspects, process 402 may ensure that aliased card data is accurately linked to its corresponding raw card data and securely stored in a central vault, even in scenarios where network connectivity or system resources may be limited.

As illustrated, process 402 may begin with a triggering event 404, such that may necessitate reconciliation of an aliased card. In some cases, triggering event 404 may include the system obtaining and/or accepting aliased card data, such as from a merchant, vendor, user, or other system, at operation 406. Once the aliased card data is accepted, the system evaluates whether a connection is available for reconciliation, as determined at operation 408. The connection available for reconciliation 408 operation ensures that the system dynamically assesses the availability of network or system resources required to acquire raw card data. If a connection is available, the system proceeds to utilize the connection to acquire raw card data at operation 410, where the aliased card data is used to retrieve the corresponding raw card data securely.

After acquiring the raw card data, the system securely stores or vaults the card data in the central vault, such as vault 106 described above, at operation 412. This centralized storage enhances data security and facilitates efficient management of sensitive data. If no connection is available for reconciliation, the system generates an error, as represented by operation 414. In some cases, operation 414 may include notifying the user or system of the failure to reconcile the aliased card data, allowing for appropriate corrective actions. This error-handling mechanism ensures that the system remains robust and provides clear feedback in scenarios where reconciliation cannot be completed.

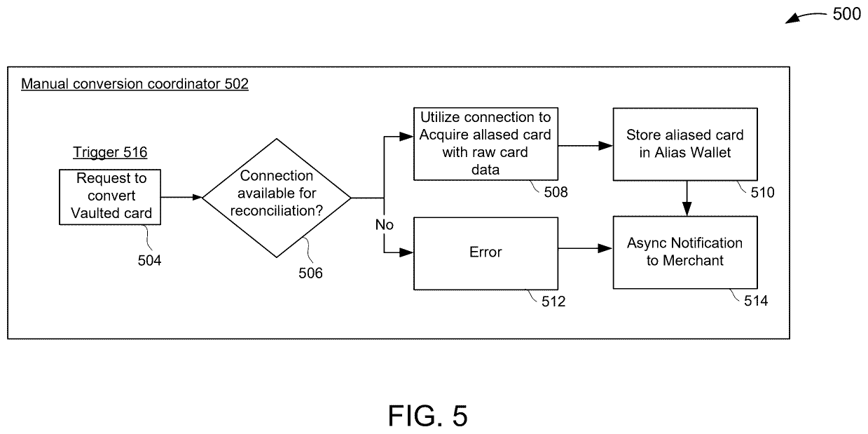

FIG. 5 illustrates a diagram 500 of an example process 502 for converting sensitive data, such as credit card or other transaction data, which may be performed by the aliased card coordinator 108 of FIG. 1. In some cases, process 500 may be initiated upon a trigger event, such as a request to convert card data. In some cases, system users can manually convert data stored within the vault 106 at any time. In some cases, process 502 includes utilizing the aliased data stored within the centralized vault 106 to directly utilize a connection with the any aliased token or universal token (from the vault 106) to generate an aliased token from a connection (e.g., as may be established by the transaction orchestrator 114).

As illustrated, process 502 may begin with a triggering event 516, which initiates the manual conversion workflow. The triggering event 516 may include a user or system event, such as a request to convert vaulted card, as represented at block 504. Upon receiving the request to convert vaulted card 504, the system evaluates whether a connection is available for reconciliation, as determined at operation 506. Operation 506 ensures that the system dynamically assesses the availability of network or system resources required to retrieve raw card data and perform the conversion. If a connection is available, as determined at operation 506, the system proceeds to utilize connection to acquire aliased card data with raw card data, at operation 508. In this step, the system securely retrieves the raw card data associated with the vaulted card and uses it to generate aliased card data. The aliased card data is then securely stored in the alias wallet 510, which serves as a centralized repository for managing aliased card data. The alias wallet 510 ensures that the aliased card data is securely stored and readily accessible for future transactions.

After storing the aliased card in the alias wallet 510, the system may send a notification to a merchant system or service, at operation 514. In some cases, the notification may be asynchronous. In some examples, the notification informs the merchant system that the aliased card has been successfully created and stored, enabling the merchant to proceed with transactions or other operations involving the aliased card. If no connection is available for reconciliation, as determined at operation 506, the system generates an error at operation 512. In some cases, operation 512 includes notifying the user or system of the failure to convert the vaulted card, allowing for appropriate corrective actions. This error-handling mechanism ensures that the system remains robust and provides clear feedback in scenarios where the conversion cannot be completed. In various cases, process 502 provides a comprehensive solution for manually converting vaulted card data into aliased card data. This approach is particularly beneficial for applications involving financial transactions, where data security, reliability, and fault tolerance are critical.

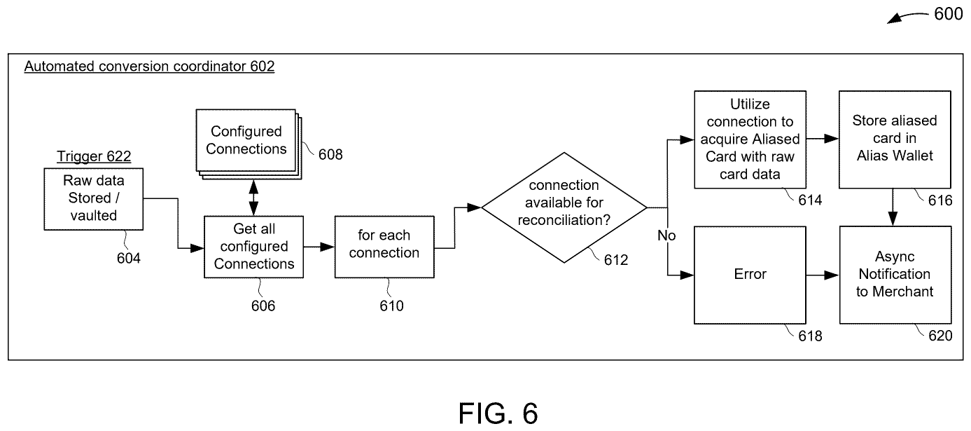

FIG. 6 illustrates a diagram 600 of another example process 602 for converting sensitive data, such as credit card or other transaction data, which may be performed by the aliased card coordinator 108 of FIG. 1. Process 602 may be automatically performed, such as upon the occurrence of a specified triggering event. In some cases, if raw data is stored within or by the aliased card coordinator 108, an automated service will automatically retrieve aliased data for all available connections, and may store and deliver the aliased data asynchronously to the system user.

As illustrated, process 602 may begin with a triggering event 604, which initiates the automated conversion workflow. In some cases, the triggering event 604 may include the storage of raw card data or the need to update aliased card data, at operation 604. Once triggered, the system retrieves available configured connections 608 through the get all configured connections 606 operation. These connections represent the pathways through which the system can interact with external services or systems, such as to exchange and/or modify sensitive data, including card data.

The system then iterates through each of the configured connections 608 in performing one or more of operations 612, 614, 616, 618, and 620. This ensures that all available connections are evaluated for their suitability in performing the conversion. At each iteration, the system determines whether a connection is available for reconciliation, at operation 612. This step dynamically assesses the availability of network or system resources required to acquire aliased card data. If a connection is available, the system proceeds to utilize the connection to acquire aliased card using the raw card data, at operation 614. In this step, the system securely retrieves the raw card data associated with the vaulted card and uses the connection to acquire an aliased card. The aliased card is then securely stored in the alias wallet 616, which serves as a centralized repository for managing aliased card data. The alias wallet 616 ensures that the aliased card data is securely stored and readily accessible for future transactions. After storing the aliased card in the alias wallet 616, the system sends a notification (e.g., an asynchronous notification) to merchant 620. This notification informs the merchant that the aliased card has been successfully created and stored, enabling the merchant to proceed with transactions or other operations involving the aliased card.

If no connection is available for reconciliation, as determined at operation 612, the system generates an error 618. Operation 618 may include sending a notification to a user or system of the failure to convert the vaulted card, allowing for appropriate corrective actions. This error-handling mechanism ensures that the system remains robust and provides clear feedback in scenarios where the conversion cannot be completed.

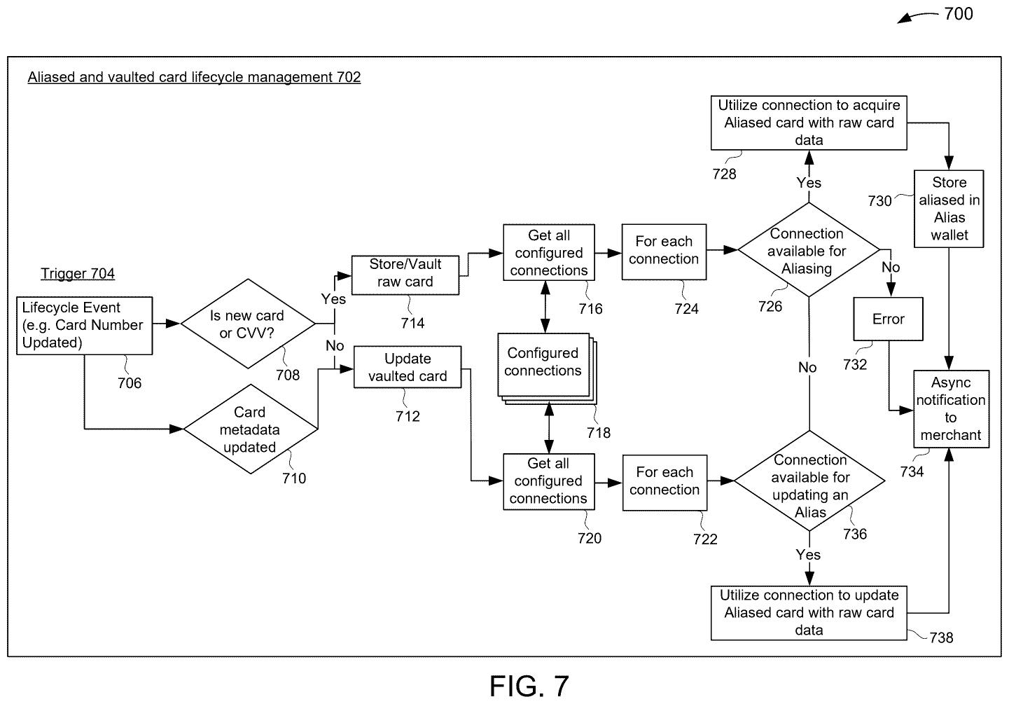

FIG. 7 illustrates an example process 700 for lifecycle management of sensitive data, such as credit card or other transaction data, which may be performed by the aliased card coordinator 108 of FIG. 1. In some cases, process 700 may be performed to ensure that lifecycle events are handled adequately across the entire alias wallet. When a lifecycle event is handled for a vaulted card, it is also handled for all aliased cards according to the features available through its connection. In this way, changes to the underlying card data may be effectuated and synchronized such that all systems interfacing with the transaction orchestration system 102 may utilize the same data. This may be particularly beneficial when card data is changed or updated, ensuring that the changes are utilized throughout the entire system.

The process begins with the occurrence of a triggering event 704, which initiates the lifecycle management workflow. The triggering event 704 may include a lifecycle event 706, such as a card number update, a change in the card verification value (CVV), or other updates to card data. The system evaluates whether the event involves a new card or CVV at operation 708. If the event involves a new card or CVV, the system securely stores or vaults the raw card data at operation 714. If the event does not involve a new card or CVV the system updates the metadata of the vaulted card at operation 712. Once the card data is stored or updated, the system retrieves all available configured connections 718 at operations 716 (after operation 714 has been performed) or 720 (after operation 720 has been performed). In some cases, these connections represent the pathways through which the system can interact with external services or systems to perform aliasing or updating operations.

For each retrieved configured connection, at operation 724, the system may perform a number of operations (e.g., iteratively) to generate aliased card data relating to the lifecycle event for the vault/raw card data. In some cases, the system iterates through each of the configured connections 718 to determine their availability for aliasing. For example, at each iteration, the system, in some cases, evaluates whether a connection is available for aliasing at operation 726. If a connection is available, the system utilizes it to acquire an aliased card using the raw card data at operation 728. The aliased card is then securely stored in the alias wallet, at operation 730, which serves as a centralized repository for managing aliased card data. The system may send a notification (e.g., an asynchronous notification) of the successful completion of operation 730 to a merchant, at operation 734. If no connection is available for aliasing, the system generates an error at operation 732 and, in some examples, sends a notification (e.g., an asynchronous notification) to merchant 734 to inform the merchant of the issue.

In parallel, for an update vaulted card lifecycle event, the system retrieves all configured connections 718 again using the get all configured connections 720 operation to check for connections available for updating an alias. In some cases, the system iterates through each of the configured connections 718 to determine their availability for updating an alias, at operation 736. If a connection is available, the system utilizes it to update the aliased card with the raw card data via operation 738. This ensures that the aliased card remains synchronized with the vaulted card data. The system may send a notification (e.g., an asynchronous notification) of the successful completion of operation 738 to a merchant, at operation 734. As described above, process 702 may provide seamless lifecycle management of sensitive data, such as card or other payment or financial data, or any other data for which data security may be useful and/or required by various data regulating organizations. In yet some cases, process 702 provides a comprehensive solution for managing the lifecycle of aliased and vaulted card data. Process 700 may ensures secure, reliable, and efficient handling of sensitive payment data. This approach is particularly beneficial for applications involving financial transactions, where data security, reliability, and fault tolerance are critical.

FIG. 8 illustrates a diagram 800 of an example universal token 802, which may be utilized by the system of FIG. 1. In some aspects, throughout an alias's lifecycle, a system user may retrieve either a single alias for a specific connection or a universal token containing information about all connected connections to be used within the unified transaction orchestration library 122. As used herein, a universal token may store details about some or all aliases and additional information (network transaction ID, etc.) for a given raw card data. This format may return a single data string that can be certified and decoded to abstract the alias values and additional payment method details used within a system. In some cases, this universal token may also include an encrypted version of the raw card data. This format is similar to and not limited to a JWT (JSON web token). The universal token may, in some cases, only store aliases to the raw card data and never the raw card data itself.

In some cases, a universal token 802 may serve as the central identifier for a payment method or reference for other sensitive data. In some cases, the universal token 802 is a unique, secure representation of the underlying payment data and is designed to interact with various components of the transaction orchestration system 102. In some cases, the universal token 802 is generated and managed by the system to ensure compatibility across multiple platforms and services. As illustrated, universal token 802 may include a primary identifier 804, which may take any of a number of different formats. The format may define the structure and encoding of the token. The universal token format 804 ensures that the token can be securely transmitted and interpreted by different systems. An example of the universal token format 804 is shown in example potential format 816, which illustrates how the token may be encoded to include secure identifiers and metadata.

In various cases, the universal token 802 is associated with any of a number of different aliases 806, 808, 810, and 812, each of which represents a unique identifier for the same underlying payment method. In some cases, the aliases 806, 808, 810, and 812 are generated and managed by the aliased card coordinator 108 and stored in an alias wallet. In some cases, each alias 806, 808, 810, and 812 is designed to interact with specific merchants, vendors, or payment processors, enabling the system to maintain compatibility with various external systems while preserving the security of the underlying payment data.

In some cases, in addition to the aliases, the universal token 802 is linked to payment method details 814, which include the raw or vaulted card data associated with the token. In some cases, the payment method details 814 are securely stored in the vault 106 and managed by the storage coordinator 104. These details ensure that the system can retrieve and update the underlying payment data as needed, such as during lifecycle events or when interacting with the transaction orchestrator 114. By leveraging the universal token 802, universal token format 804, aliases 806, 808, 810, and 812, payment method details 814, and example potential format 816, the system ensures secure, reliable, and efficient handling of sensitive payment data. This approach is particularly beneficial for applications involving financial transactions, where data security, compatibility, and scalability are critical.

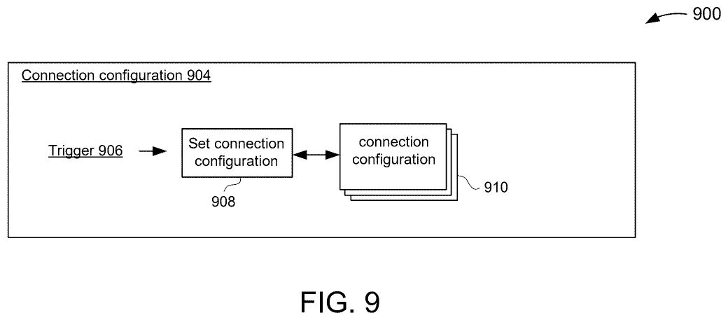

FIG. 9 illustrates a diagram 900 of an example processes 904 for configuring a connection for a transaction involving sensitive data, which may be performed by the transaction orchestrator 114 of FIG. 1. In some cases, any connection utilized from the unified entry points may be configured before an entry point is invoked. This configuration may contain any vendor-specific configuration required to enable it. In some aspects, a unified transaction orchestration library, such as unified transaction orchestration library 122 of FIG. 1, may serve as the central component for managing the lifecycle of connection configurations. In various cases, the transaction orchestrator may utilize and interact with a unified transaction orchestration library and implement processes that ensure that connections between merchants, vendors, and vaults are dynamically established, updated, and maintained to support seamless transaction orchestration.

Process 904 may begin with a triggering event 906, which initiates the connection configuration workflow. The triggering event 906 may include onboarding of a new merchant, the addition of a new payment processor, or the need to update an existing connection. Once triggered, the system proceeds to set or generate the connection configuration, at operation 908, where the parameters for the connection are defined and applied. The set connection configuration operation 908 ensures that the connection is properly configured to meet the requirements of the merchant, vendor, or vault system. The set connection configuration operation 908 interacts with the connection configuration 910, which represents the repository of all configured connections within the system. The connection configuration 910 stores the details of each connection, including authentication credentials, endpoint URLS, and other metadata required for secure communication with external systems. This repository ensures that all connection configurations are centrally managed and accessible for future updates or modifications.

The connection configuration 904 may include multiple configurations, as represented by the connection configuration stack 910. The connection configuration stack 910 allows the system to manage multiple connections simultaneously, enabling seamless integration with various payment processors, vendors, and merchants. The stack structure ensures that the system can prioritize and switch between connections as needed, providing fault tolerance and flexibility in the event of network disruptions or system failures. In some cases, process 904 provides a comprehensive solution for managing connection configurations within a unified transaction orchestration library. This approach is particularly beneficial for applications involving financial transactions, where dynamic configuration, scalability, and fault tolerance are critical.

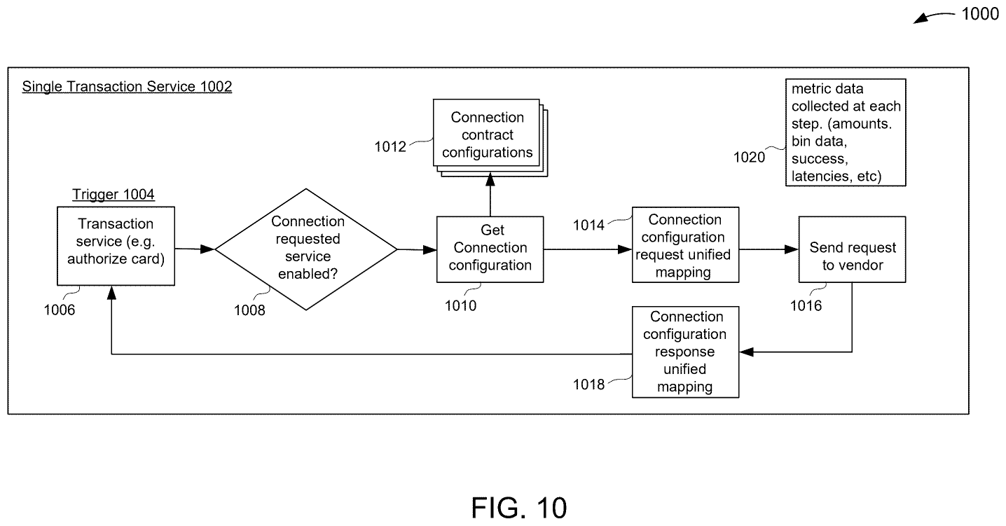

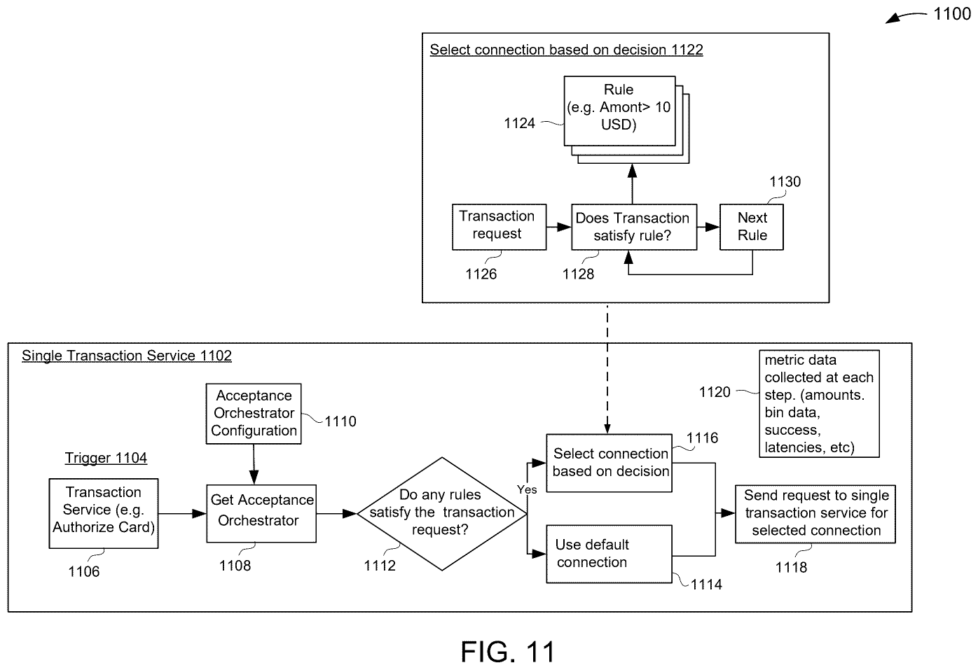

FIGS. 10 and 11 illustrate example diagrams 1000 and 1100 of processes 1002 and 1102 for facilitating a transaction involving sensitive data, which may be performed by one or more components or processes of the transaction orchestration service 102, such as the transaction orchestrator 114, of FIG. 1. In various cases, processes 1002 and/or 1102 may provide secure, efficient, and dynamic handling of transaction requests by leveraging connection configurations and unified mappings to interact with external vendors.

In various cases, either of process 1002 and 1102 may enable the direction utilization of a single connection to process a transaction utilizing sensitive data, such as payment data or credit card information. The service endpoint may be exposed to provide any of a variety of transaction lifecycle services directly to any connection, including but not limited to: charge payment method, authorize charge (including payment intents), capture charge, void, refund etc. In various examples, an acceptance orchestrator (e.g., transaction orchestrator 114) can handle an incoming entry point (rule configurations) and facilitate which connection will be utilized. These configurations may utilize any value available during a transaction service invocation and the responses from a service invocation to enable full customization of where to route a transaction. A user interface (UI), UI library, or embeddable UI may additionally be provided to enable the generation of the acceptance orchestrators to simplify the configuration of an acceptance orchestrator. For example, an orchestrator may be configured to utilize a first connection when the charged amount is over 100 USD and utilize another when equal to or under 100 USD. As illustrated in FIG. 11, in various other cases, various rules may be defined via Boolean logic or other notation, to further customize routing of different transaction requests, based on, for example, attributes of the transaction itself (e.g., amount limits or ranges), attributes of the consumer (e.g., location), based on vendor, merchant, or type of the vendor or merchant, location, types of transactions and purchases, and so on.

Referring to FIG. 10, process 1002 begins with a triggering event 1004, which initiates the transaction workflow. The triggering event 1004 may include an action taken by a user or a system event, such as a request to authorize a payment or process a financial transaction, at operation 1006. The system then evaluates whether the requested service is enabled at operation 1008. This step ensures that the system dynamically determines whether the necessary connection configurations are available to process the transaction. If the service is enabled, the system proceeds to obtain the connection configuration at operation 1010, where the appropriate connection details are retrieved from the connection contract configurations 1012. The connection contract configurations 1012 serve as a repository of pre-configured contracts that define the parameters for interacting with external vendors, including authentication credentials, endpoint URLS, and other metadata.

Once the connection configuration is retrieved, the system applies a connection configuration request unified mapping, at operation 1014. This mapping standardizes the request format to ensure compatibility with the external vendor's system. The unified mapping operation 1014 ensures that the transaction request adheres to the vendor's requirements while maintaining the integrity of the data being transmitted. The system then sends the transaction request to the vendor at operation 1016. The vendor processes the request and returns a response, which includes the connection configuration unified mapping at operation 1018. This mapping standardizes the vendor's response format, ensuring that the data can be seamlessly integrated back into the transaction orchestration system.

In some cases, throughout process 1002, the system collects metric data 1020 at one or more operations of process 1002. In some cases, the metric data 1020 includes information such as transaction amounts, bin (bank identification number) data, success rates, latencies, and other performance metrics. This data is used to optimize the transaction orchestration system, enabling improvements in cost efficiency, latency reduction, and overall system availability. In various cases, process 1002 provides a comprehensive solution for managing single transaction services within a transaction orchestration system. This approach is particularly beneficial for applications involving sensitive payment data, where security, scalability, and performance are critical.

Referring to FIG. 11, process 1102 may be initiated by the occurrence of a triggering event 1104, which may include a request to authorize a payment or process a financial transaction, such as from a user device or external service. In some examples, the request may include a request to authorize a card, capture a payment, or void a transaction. The system then retrieves the acceptance orchestrator configuration 1110 via a get acceptance orchestrator operation 1108. The acceptance orchestrator configuration 1110 defines the rules and parameters for evaluating transaction requests and selecting connections. In some cases, these rules are stored in a repository and are dynamically applied to ensure compatibility with external systems. The system evaluates whether any rules satisfy the transaction request at operation 1112. If no rules are satisfied, the system defaults to a pre-configured connection using a use default connection at operation 1114. If one or more rules are satisfied, the system proceeds to select a connection at operation 1116 based on connection decision 1122, where the most appropriate connection is chosen based on pre-defined rules, heuristics, machine learning, or various other selection mechanisms.

In some aspects, the connection decision 1122 may be performed by a rule-based decision engine, which evaluates the transaction request against a set of predefined rules. As illustrated, one example rule set may include various rules for an amount of a requested transaction. It should be appreciated that other rules, based on other metrics may similarly be implemented, such as based on time, location, vendor, merchant, user history data, transaction history data, and various other metrics. Each rule, such as rule 1124 (e.g., “amount >10 USD”), is applied to the transaction request 1126 to determine whether the request satisfies the rule. If the rule is satisfied, as determined at operation 1128, the system selects the corresponding connection. If not, the system evaluates the next rule at operation 1130 until a suitable connection is identified.

Once a connection is selected, the system sends the transaction request to the selected connection at operation 1118 process. The selected connection processes the request and returns a response, which is integrated back into the transaction orchestration system.

In some cases, throughout process 1102, the system collects metric data 1120 at one or more operations of process 1102. The metric data 1120 includes information such as transaction amounts, bin (bank identification number) data, success rates, latencies, and other performance metrics. This data is used to optimize the transaction orchestration system, enabling improvements in cost efficiency, latency reduction, and overall system availability.

In some cases, the acceptance orchestrator may utilize various data as inputs, such as any data provided to the acceptance orchestrator from a system user, universal token, universal transaction, partner responses, etc. In some cases, for validation and error handling, real-time input data validation may be provided, to ensure that rules are correctly configured, whereby immediate (e.g., real-time or near real-time) feedback for errors or missing information can be provided. In some examples, components to define conditional logic (e.g., if-else conditions) based on transaction attributes or external data inputs may be supported. This logic may be defined as configuration or through code-based functions. In yet some aspects, integration points may fetch dynamic data (e.g., currency exchange rates, user data) and trigger external APIs during the payment process.

In some aspects, the described systems and techniques may additionally include a visual workflow designer. The workflow designer may include or provide flowchart components, including graphical representations of the payment process, showing the rules and decision points sequence. In yet some cases, the workflow designer may include or provide Drag-and-Drop Functionality to enable users to visually arrange and reorder rules and actions within the payment workflow. In yet some cases, the workflow designer may include or provide a node-based editor, which may allow users to create and connect nodes representing different steps in the payment orchestration process, such as payment methods, conditional logic, retries, and error handling. In yet some cases, the workflow designer may include or provide rule templates, which may be pre-defined rule templates that can be customized or used to speed up configuration.

In some aspects, the described systems and techniques may additionally include or support connection contract configurations. In some cases, this may include a single contract representation of all connection transaction services to enable SDKs of any language to expose all connection services. This representation may contain mappings for endpoints and properties, transforms for properties, communication protocols, validation and authentication protocols, and any additional information to successfully facilitate a single contract to a multi-contract library. These services and configurations may enable the connection between any service that enables the movement of money (or sensitive data) from a consumer to a merchant, including credit card processing, bank-to-bank account transfers, or any other alternative payment method.

In this model, a contract may contain one or more of the following properties. In some cases, a contract may include service information, such as endpoints, authorization details, features available, etc. In some cases, a contract may include request and response contract mappings per service, including a map of transport details into a unified contract for each service. Examples include, but are not limited to endpoint mapping, header mappings, status code mappings, property mapping, transformations (text transforms, number transforms, concatenation, truncation, etc.), and successful result mappings. In some cases, a contract may also include a map of errors to a single unified contract for each service: service errors, payment errors, transaction errors, etc.

In some cases, the described systems and techniques may additionally support data streams that can provide a unified data analytics source, enabling organizations to send unified data to their payment data analytics aggregator or metrics/logging aggregator to enable detailed transaction performance analysis.

In some cases, the described systems and techniques may additionally provide universal transactions. A universal transaction may store additional information in single or multiple encoded text responses to ensure consistency between transactions for the same raw card data across multiple connections. The data available to store within a universal transaction will vary and may include any property response from a transaction connection, this may consist of be and is not limited to: scheme or network specific transaction identifiers, transaction history on behalf of context and/or payment card options utilized, (installments, 3DS, mandate options), shipping information, fraud identifiers and details for each transaction, and/or last transaction success, cancellation, or failure reasons.

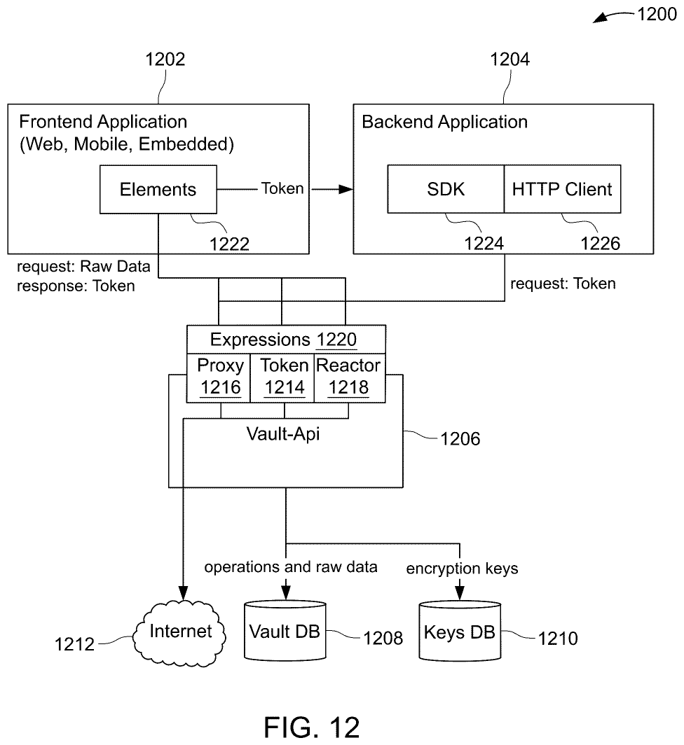

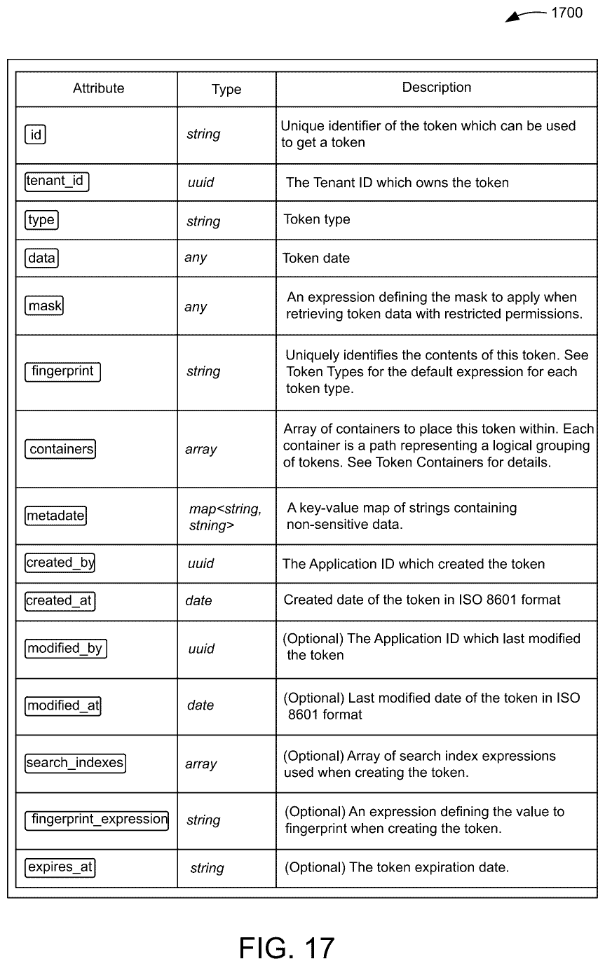

In some aspects, the described system and techniques related to transaction orchestration, as described above, may be implemented in conjunction with and/or utilize various components and processes of a tokenized data system as described below with reference to FIGS. 12-19. As described herein, similarly named components and processes may share one or more aspects, or be examples of one another, as dictated by context.

In some aspects, systems and methods are described herein relating to tokenizing data, such as sensitive data. In some aspects, the described systems and techniques enable users to encrypt, tokenize, and store any payload securely. The described systems and token infrastructure can be used to protect data at rest, as it passes between a user's internal systems, or how it's permissioned and shared with third parties. In various aspects, the described techniques may ingest sensitive data and tokenize the data, creating a reference to the data, which can be shared with other applications, systems, etc., without having to expose the underlying sensitive data. By utilizing a token structure, compliance with various compliance standards may be obviated on customer side systems and applications, thus reducing the complexity and resource burden to interact with various forms of sensitive data.

The described systems and techniques may provide for various ways to ingest, tokenize, store, perform operations on, and transfer sensitive data. In some cases, isolated execution environments, referred to as reactors, may provide for isolated functions to be performed on sensitive data and tokenized data alike, such that tokenized data or raw data may be input or output from customizable reactors. In some cases, reactors may provide the ability to run serverless code inside of the described secure platform to perform manipulations and/or transfer of data without that data touching customer's systems. In some cases, reactors may provide encrypted data analysis, such that multiple sets of data may be analyzed without the sensitive data being exposed to customer's systems. In some cases, reactors or functions within reactors may be combined to produce streamlined workflows to perform various operations on the data. In some cases, a library may be created and maintained, such that a number of different workflows may be pre-configured and accessible across the platform to various customers.

The described systems may also provide for proxies, which may enable customers and authorized third parties to view, or instruct the tokenized data system or platform to allow other authorized systems to view, certain elements of tokenized data by directly accessing the a token vault service, without necessitating a transfer of data from the tokenization system or service to the customer systems or other authorized 3^{rd} party endpoints. This enables more efficient and compliant use of sensitive data stored within the tokenization system or service by customers and authorized third parties. In some cases, proxy transforms may provide the ability to manipulate the request and response body of an HTTP request with serverless functions running inside a secure environment. This enables the ability to manipulate requests before and after they have reached their destination all without having those requests or data touch customers systems. In yet some cases, customizable input elements may also be provided by the described system, to enable secure and isolated capture of sensitive data through customer web pages, applications, etc.

In some aspects, the described systems and techniques may enable building search indexes that provide the ability to search on encrypted data (e.g., token data) without needing to decrypt to re-expose the underlying data. Here search indexes may be created based on the sensitive data such that the search indexes will operate on data that has been tokenized already. This feature enables custom search indexes to be constructed, such that a customer can customize what information is available for searching tokenized data. In some cases, a user can indicate which data to index, the data is hashed, and the resulting hashes are indexed, such that a search operation may search through hashes. In some aspects, versioned tokens enable lineage to be tracked between changes of the underlying token data.

In various examples, various functions may be provided at least in part through the use of a custom templating language, e.g., expressions, which enable the ability to use a templating language to transform original data into something different. For example, expressions may enable changing “12345” to “1****” without touching the underlying data. The use of a templating language, such as expressions, may enable the robust creating of customization of various reactor functions to interact with the data.

The described techniques may also support and include fingerprinting, which may provide the ability to understand uniqueness across tokens. In some aspects a fingerprint may be created based on features of the data, and a hashing function used to create a unique identifier that points to the hash, to avoid exposing any sensitive data to customers. The described techniques may also support and include custom masks, which may provide the ability to create nearly any mask of the underlying tokenized data without needing the customer systems to touch or handle it. In some cases, a custom mask may be created using a templating/scripting language, such as expressions. For example, a custom mask may be created that includes last 4 numbers of a SSN.

In some aspects, customers can use their own database to store the underlying encrypted data to limit exposure to the tokenized data system needing to store both the keys and the data. Here, it may be beneficial to store the data and the keys to decrypt that data in different locations and/or by different actors, such that neither customer nor computing resource provider can unilaterally decrypt data in case of a security breach. In yet some aspects, the described systems and techniques may provide for tenants, or logical groupings, such as in secured execution environments, of applications and/or tokens. Common use cases for tenants may be to create one per environment such as development, QA, and production, or to isolate business domains from each other. In some aspects, tenant data is isolated from other tenants unless explicitly shared. In some aspects, the tenant logical structures may be provided in addition to various identity and access management measures and services.

FIG. 12 illustrates an example of a tokenized data system 1200. System 1200 may include a number of different entities that generate, transfer, and/or modify tokens 1216, such as one or more frontend applications 1202, one or more backend applications 1204, a vault interface or API 1206, which may be in communication, via one or more networks, with a vault database 1208 and a keys database 1210. In some aspects, the vault interface 1206 may also be connected via one or more networks with the internet 1212, such as to enable various user/organizations to send data to 3^{rd} party endpoints, (e.g., payment processors, payment networks, and other endpoints). At the core of the tokenized data system 1200 is the use of tokens 1214, which can be used by frontend applications 1204, backend applications 1204, proxies 1216, reactors 1218, and third parties via various 3^{rd} party endpoints accessed via the internet 1212, to store, modify, an access sensitive data without requiring that the underlying sensitive data be exposed.

A user or customer may upload or otherwise import data, such as sensitive data into system 1200 via a number of different ways, including through a device, such as using a frontend application 1202, backend application 1204 (e.g., using one or more SDKs 1224 or HTTP clients 1226) one or more APIs, such as vault API 1206, etc., one or more reactors 1218, and various other ways. In some aspects, specific types of data may be ingested through one or more elements 1222 (provided through a web application for example). An element 1222 is a simple and secure input or inputs that empower developers to collect sensitive data from users or to reveal sensitive data back to users, all without having direct access to the plaintext data. This may be particularly advantageous, such as to avoid the need for customer applications to meet various compliance standards. Any application code that interacts with sensitive regulated data can be subject to costly and time-consuming audits to prove that the application meets various compliance standards (e.g. PCI-DSS, HIPAA, SOC 2, ISO-27001). Using Elements 1222 can remove frontend applications from compliance scope, saving time, cost, and complexity.

In some cases, elements 1222 may provide a frontend application 1202 that end users are able to seamlessly interact with, and which securely communicates with system 1200*(e.g., the vault database 12087 via vault API 1206) to tokenize or detokenize data. Sensitive data is not directly exposed to the application code, and only the non-sensitive token identifiers are exposed to be referenced within customer systems. An example process of using elements 1222 is described below. One or more element SDKs 1224 may be installed into a user web or mobile application (e.g., part of frontend 1202). One or more forms, such as for inputting data, with a number of data fields, may be built using element inputs as components. The elements 1222 may then interact with the vault API 1206 using element references, not plaintext data.

In some cases, data entered by end users into an elements is tokenized and secured within the vault data base 1208, without the application needing to have direct access to this data. SDKs 1224 may be provided by system 1200 and may provide a number of different types of inputs to collect various types of data, such as the card_element for collecting credit card data and text_element for collecting arbitrary textual data. In some cases, elements 1222 can be configured to support custom input masking, validation, and transformation rules to satisfy unique requirements. Various SDKs 1224 may be provided to collect data from various sources and of a variety of formats, including data from the web, collecting data with reactors 1218, collecting data with various operating systems (e.g., Android, IOS). In some aspects, sensitive data may also be revealed through one or more elements 1222. In these scenarios, tokens 1214 stored within the vault database 1208 can be securely revealed to end users without accessing the plaintext data directly the application code. Using a provided SDK, sensitive data can be securely retrieved and applied to one or more elements within a given user interface. In some aspects, the SDK may manage encapsulating the sensitive data so that the application can reference these value without having direct access to it.

In some aspects, elements 1222 may enable retrieve/reveal functionality. In this example, a proxy may be utilized to request sensitive information from another service (for example a CVC for an issued card) and display that data directly into the input in a browser via one or more elements. In this way, the request and CVC may never touch the backend or frontend code of the customer.

The vault interface or API(s) 1206 may provide various interfaces for ingesting raw data, generating tokens 1214, transforming token data using reactors 1218, such as facilities by expressions 1220, and/or communicating tokenized and raw data via proxies 1216, and/or storing and accessing data through the vault database 1208 and/or keys database 1210, as will be described in greater detail below. The vault database 1208 and/or the keys database 1218 may include any of a variety od data storage devices, services, etc., including hardware, cloud computing resources and the like. In some cases, the vault database 1208 may store raw data, such as may be sensitive, and may be in compliance with various standards, etc. In some cases, the vault database may additionally or alternatively store tokens, such as may include a token identifier of some type (e.g., obfuscated parts of the underlying sensitive data) as well as the sensitive data itself or a refence to the sensitive data, such as when the sensitive data may be stored in a different location, system, service, etc. (e.g., stored by the customer). In some cases, the data, either in raw form and/or the tokenized data may be stored in an encrypted state, whereby the leys to that encryption may be stored in a separate database or data store, the key database 1210. In some cases, vault database 1208 and key database 1210 may be comprise a single database or database instance, such as provided by a computing resource service provider.

In some implementations, system 1200 may include the vault API or interface(s) 1206, vault dataset 1208, keys database 1210, and in some aspects elements 1222, such as associated with one or more frontend applications, and/or SDKs and HTTP clients 1224, 1226 of one or more backend applications. In yet some aspects, part or all of frontend application(s) 1202 and/or backend applications 1204 may be provided at least in part by a customer, such that elements 1222, SDKs 1224, and/or HTTP clients 1226 may be provided by system 1200 and interact with front end application(s) 012 and/or backend application(s) 1204 provided by customer computing resources.

Tokens 1214 may form the basis of the tokenized data system 1200. A token 1214 may include any reference to the sensitive data that's stored in another, secure location, such as in the vault database 1208 or at a user or customer managed data storage. A token 1214 may include a reference to sensitive data that is generated based on the underlying sensitive data. In some examples, a token 1214 may include part of the sensitive data, but not all of the sensitive data (e.g., the last four numbers of a credit card or other bank card). In yet some examples, a token 1214 may include an obfuscated or otherwise modified part or all of the sensitive data (e.g., a completely or partially modified phone number or address). An example of a token data structure or object is illustrated in FIG. 6. It should be appreciated, that in some aspects, one or more of the data fields may be omitted, and/or one or more of the data types may be changed.

Tokens 1214 may enable the transfer of raw data into tokenized data system 1200, whereby the system 1200 generates and returns a non-sensitive token identifier to reference in other processes, systems, or storage locations. In some cases, upon ingesting customer data, the data may be encrypted via any of a variety of encryption technologies, such as NIST and FIPS-compliant encryption algorithms. In some cases, a one-time use encryption key is used, which is then encrypted again and stored within the system, such as in keys database 1210. This foundational encryption ensures the data is uniquely encrypted each time a new token is created, thus preventing different customers' encryption keys from being co-mingled.

Various types of data may be ingested by system 1200 and tokenized, including any primitive, complex, or unstructured data. Examples of data that may be ingested include a user record, a simple social security number, or the contents of a file. In some cases, preconfigured and configurable token types are provided, such as card and bank types, health information (e.g., data governed by HIPPA), personal information (PII), and so on, to simplify integration by offering pre-configured capabilities.

In some cases, system 1200 enables management of the full lifecycle of tokens, including creating, updating, reading, detokenizing, searching, and deleting tokens. In some cases, system 1200 offers the ability to also create tokens in bulk via the tokenize API endpoint. This endpoint provides a way to create multiple tokens while preserving a specified format. In some cases, a token time to live (TTL) capability can be implemented to expire tokenized data.

In some aspects, the described tokens 1214 utilize a specification that enables transformation of data to optimize for storage, readability, searching, and permissions. System 1200, in some aspects, utilizes template language (e.g., Liquid template) expressions 1220 to enable full control over all parts of tokenized data. The template language expressions 1220 may provide a more intuitive and accessible way to perform operations on tokenized data, as will be described in greater detail below. The vault API 1206 enables interactions with sensitive data through tokens 1214 (and expressions 1220) via proxies 1216 and reactors 1218. Which will each be described in greater detail below.

A proxy 1216 may be a network endpoint that enables the use of tokens with HTTP APIs without needing to access sensitive data directly within customer systems. The use of proxies 1216 enables solving both these problems securely while keeping customer systems out of compliance scope. It is a common need to share data between software systems via HTTP based APIs.

In some cases, the use of proxies 1216 may address the situation of using an outbound HTTP request from a customer's system that requires a piece of sensitive data that has already been tokenized, without having to access the sensitive data directly within a customer application. Proxies 1216 may also address the situation where a customer API receives inbound HTTP requests that contain sensitive data by tokenizing the sensitive data before it hits customer servers. In some aspects, there are two primary options when proxying HTTP requests: using an ephemeral proxy and using aa pre-configured proxy. An ephemeral proxy may be implemented by invoking a proxy API endpoint and specifying the configuration in the request. No configuration is needed ahead of time. This option is best for basic use cases. For a pre-configured proxy, first a proxy instance may be configured, and it may then be invoked it by its unique key. This option is best for more complex use cases requiring custom request or response transforms. Example system interactions for outbound and inbound request using proxies will be described in greater detail below in reference to FIGS. 3 and 4.

A reactor 1218 is an isolated execution environment that can be configured to perform any of a number of functions on and with tokens, such as may be invoked by systems and resources accessed via the internet 1212 and/or HTTP client requests 1226 of one or more backend applications 1204. In some aspects, a reactor 1218 is a serverless compute service allowing Node.js code hosted by system 1200 to be executed against tokens 1214 completely isolated away from other applications and systems. Reactors 1218 are invokable from any system that has the ability to make HTTPS requests and access the internet 1212. In some examples, reactors 1218 may include serverless function runtimes, similar to AWS Lambda, Azure Functions, or Cloudflare Workers—except the applications, systems, and infrastructure never touches the sensitive plaintext data, but operates on tokens 1214. Example system interactions with a reactor 1218 will be described in greater detail below in reference to FIG. 5.

Various features and capabilities, made possible by the token specification, and more broadly system 1200, will now be described. One feature provided by system 1200 may include aliasing. In some scenarios, it may be useful and/or necessary to interact with various services to have a token identifier be in a specific format, such as to pass existing validation requirements, and/or interface with an existing data format or database schema that is hard to change. Aliasing provides a simple way to customize the format of a token identifier to meet various needs. For example, assume a social security number is being stored, and it would be useful alias the token identifier to match the SSN format:

```
Request
  {
    “id”: “{{ data | alias_preserve_format }}”,
    “type”: “token”,
    “data”: “XXX-45-6789”
  }
Response
  {
    “id”: “XXX-28-3948”,
    “type”: “token”
  }
```

Another example may be a desire to format email and retain the domain on the email while preserving the length of the email identifier, such that enables searching for an instance of the email domain in a database without exposing the actual email addresses:

```
Request
  {
    “id”: “{{ data | split: ‘@’ | first | alias_preserve_length }}@{{ data | split: ‘@’ | last
  }}”,
    “type”: “token”,
    “data”: “johndoe@basistheory.com”
  }
Response
  {
    “id”: “difkelk@basistheory.com”,
    “type”: “token”
  }
```

Another feature provided by system 1200 may include Fingerprinting, which may provide a way to correlate multiple tokens together that contain the same data without needing access to the underlying data. Creating multiple tokens in a tenant or account with the same token type, data, and fingerprint expression will generate the same fingerprint. This can be useful for correlating purchases with the same credit card for multiple members of the same household or helping with master data management of multiple user accounts. Token fingerprints are also useful for automatic deduplication of tokens within a tenant. In some cases, fingerprinting may provide the ability to understand uniqueness across tokens, in which a strong hash may be utilized and a GUID returned that points that hash to avoid exposing any sensitive data. In the following example, a token may be created with user data, where a fingerprint is generated based on the email address:

```
Request
  {
    “type”: “token”,
    “data”: {
      “first_name”: “John”,
      “last_name”: “Doe”,
      “email_address”: “johndoe@basistheory.com”
    },
    “fingerprint_expression”: “{{ data.email_address }}”
  }
Response
  {
    “id”: “1e7f0dde-5442-40ab-b244-5e02bcd5f86d”,
    “type”: “token”,
    “fingerprint”: “PH12E7vY7HfRTdGVUDeLzRcP8”,
    “fingerprint_expression”: “{{ data.email_address }}”
  }
```

In the above example, if another token is created with the email_address of johndoe@basistheory.com, the same fingerprint value of PH12E7vY7HfRTdGVUDeLzRcP8 will be returned. If a token with a different email address is created, a different fingerprint value will be returned.

One feature provided by system 1200 may include masking. Masking is a way to securely and compliantly reveal parts of sensitive data. For example, masking may be useful for revealing the last 4 digits of a credit card number to a customer during a checkout process or the last part of a social security number for a customer service representative to verify account ownership. Masks may be computed based on the current value of the token data. In some cases, updating the token will change what masked data is returned. Custom masks may provide the ability to create nearly any mask of the underlying tokenized data without needing to touch or handle it. In some cases, a custom mask may be created using a templating/scripting language, such as expressions 1220. For example, a custom mask may be created that includes last 4 numbers of SSN. One example scenario where masking is useful may be enabling customer service representatives to verify the account information for a customer using the last four of a social security number without having access to the full SSN. In this example, the customer data may be masked so representatives can securely and compliantly view only part of the customer record:

```
Request
  {
    “type”: “token”,
    “data”: {
      “first_name”: “John”,
      “last_name”: “Doe”,
      “social_security_number”: “XXX-22-3333”,
      “email_address”: “johndoe@basistheory.com”
    },
    “mask”: {
      “first_name”: “{{ data.first_name }}”,
      “last_name”: “{{ data.last_name | slice: 0 }}.”,
      “social_security_number”: “{{ data.social_security_number | reveal_last: 4 }}”,
      “email_address”: “{{ data.email_address | split: ‘@’ | last }}”
    }
  }
Response
  {
    “id”: “ae164fcd-227d-40ce-b7ec-435faa6a8c73”,
    “type”: “token”,
    “data”: {
      “first_name”: “John”,
      “last_name”: “D.”,
      “social_security_number”: “XXX-XX-3333”,
      “email_address”: “basistheory.com”
    },
    “mask”: {
      “first_name”: “{{ data.first_name }}”,
      “last_name”: “{{ data.last_name | slice: 0 }}.”,
      “social_security_number”: “{{ data.social_security_number | reveal_last: 4 }}”,
      “email_address”: “{{ data.email_address | split: ‘@’ | last }}”
    }
  }
```

Another feature provided by system 1200 may include containers, which enable logically grouping tokens and segmenting data within an account or tenant, enabling customers to organize tokens based on various data governance strategies. By default, tokens may be placed into containers based on NIST defined data classifications and impact levels. Containers allow customers to grant scoped access to subsets of Tokens, limiting the amount of data accessible by the customer's internal systems. Access controls can be used in conjunction with containers to allow some systems access to highly confidential data while restricting access to only masked or redacted tokens from other systems. For example, it may be desirable to store a customer's social security number and only provide access to the last 4 digits of the SSN to a customer service team.

Another feature provided by system 1200 may include Time to Live (TTL). The time to live token capability provides the ability to expire token data. This is useful in scenarios such as an expiring credit card, to share temporary credentials for system or user access, or meeting data retention policies. The following example an example way to expire a token with card data:

```
{
  “type”: “token”,
  “data”: {
    “number”: “4242424242424242”,
    “expiration_month”: 122,
    “expiration_year”: 2025
  },
  “expires_at”: “2025-12-31T00:00:00+00:00”
}
```

In this example, once the expires at date has passed, the entire token will be purged and no longer available.

Another feature provided by system 1200 may include auditing. In some cases, some or all activities around tokens are audited, including create, read, update, delete and whenever a token is proxied or used in a reactor. These audit logs may be generated by system 1200 and made are available via the vault API 1206 or a web portal. Also, in some cases, the creator and last modifier of a token is stored for all tokens. This can be used to lookup which application was used to create or update a token. An example process to access audit information is as follows:

```
Request
  {
    “type”: “token”,
    “data”: “John Doe”
  }
Response
  {
    “id”: “c06d0789-0a38-40be-b7cc-c28a718f76f1”,
    “type”: “token”,
    “created_by”: “fb124bba-f90d-45f0-9a59-5edca27b3b4a”,
    “created_at”: “2020-09-15T15:53:00+00:00”,
    “modified_by”: “fb124bba-f90d-45f0-9a59-5edca27b3b4a”,
    “modified_at”: “2020-09-15T15:53:00+00:00”
  }
```

Another feature provided by system 1200 may include search indexes. Once data is encrypted, it is difficult to search through the data for business processes without having full access. System 1200 enables creation of search indexes on parts of the data within a token to allow searching without requiring decrypting the underlying data or providing access to the sensitive data. In the following example, a custom index can be created to enable searching over specific fields of the customer data:

```
{
  “type”: “token”,
  “data”: {
    “first_name”: “John”,
    “last_name”: “Doe”,
    “social_security_number”: “XXX-22-3333”,
    “email_address”: “johndoe@basistheory.com”
  },
  “search_indexes”: [
    “{{ data.first_name | downcase }}”,
    “{{ data.last_name | downcase }}”,
    “{{ data.social_security_number }}”,
    “{{ data.social_security_number | last4 }}”,
    “{{ data.email_address | downcase }}”,
    “{{ data.email_address | split: ‘@’ | last }}”
  ]
}
```

In the above example, a search with john, doe, 111-22-3333, 3333, johndoe@basistheory.com or basistheory.com may be performed on token data without having to access the sensitive information itself.

In some examples, when a token is created, the data may be securely indexed in several data patterns using blind indexes. Combining the blind indexes with existing metadata on the tokens allows search functionality of large volumes of data, such as stored in vault database 1208, with a simple query. You can search over the following fields: id, type, data, fingerprint, container, metadata.[key], created by, created at, modified by, and/or modified at. In various aspects, searching data is not limited by token type, but rather driven by the presence of search indexes, which are arrays of search index expressions that can be specified within the request when creating a token. Some token types may be associated with default search indexes, but they can be overridden with custom indexes to fit various use case.

Another feature provided by system 1200 may include deduplication. Duplicate data can be problematic for some systems, such that it can potentially lead to data consistency problems as multiple copies of the data need to be kept in sync. For example, a customer may have an accounts payable system and an e-commerce system both accepting credit cards for customers, and it may be desirable to ensure a single credit card is on file for that customer as the source of truth. Deduplication may also be required within some business domains; for example, a system may collect sensitive user information and wish to match or correlate user accounts having identical information. In some cases, token deduplication can help solve these use cases by ensuring that only one copy of equivalent tokenized data can exist within a tenant or account. In some cases, by default, every tokenization request creates a new token, but with deduplication enabled at the tenant or on each tokenization request, tokens will be deduplicated based upon their fingerprint. This ensures that if multiple systems or the same system creates multiple tokens containing the same data, they do not create duplicate tokens. In some examples, to deduplicate a token during tokenization, the deduplicate token flag may be passed to the create token request. This will override the tenant-level deduplicate tokens setting for this request:

```
{
  “type”: “token”,
  “data”: “123-45-6789”,
  “deduplicate_token”: true
}
```

If an existing token is found with the same fingerprint, the existing token may be returned instead of creating a new token. When an existing token is matched, its data and metadata may only be returned within the response if the requester has token: read permission to the matched token. If the requesting application does not have read permission, then the data, metadata, and other potentially sensitive attributes may be redacted to prevent leaking information to unauthorized parties. In some cases, only the following properties will be included in redacted responses: id, type, tenant_id, fingerprint, and containers.

Another feature provided by system 1200 may include metadata. Being able to tag tokens with custom attributes is important in many scenarios. For instance, it may be useful to add a system identifier to tokens that enables referencing a record in a customer database. Another scenario may include the desire to tag records that fall into certain compliance requirements (e.g. GDPR). In these scenarios, putting this information in the token data may not be desired as it may be more beneficial to be able to quickly reference the information or expose it to audiences who do not have access to view the token data. To solve for this, tokens may enable setting custom metadata on any token utilizing key-value pairs. For example:

```
Request:
  {
    “type”: “token”,
    “data”: “John Doe”,
    “metadata”: {
      “customer_id”: “123abc”
    }
  }
Response:
  {
    “id”: “a2f1defa-da99-44e7-b70b-4e6dcfa20ec2”,
    “type”: “token”,
    “metadata”: {
      “customer_id”: “123abc”
    }
  }
```

Associations via metadata enable building relationships between data. With metadata, it is possible to construct data relationships into trees or chains enabling more efficient discovery and traversing of data. It some cases, this feature may provide the ability to manage the relationship between a parent and child token via token association API endpoints.

Another feature provided by system 1200 may include workflows, which may provide the ability to easily wire together different capabilities (e.g., transfer of data, manipulation of data such as performed by reactors, etc.) of the platform/system 1200 into a single flow. For example, three different steps may be wired together as a workflow: creating the ability to take data as an input, tokenize the data, and forward the tokenized data (or raw data in some cases) to a different endpoint. In some cases, a workflow may also provide the capabilities for batch processing, performing potentially different steps asynchronously, and so on. In some aspects, preconfigured workflows may be maintained in a library data store of the system 1200, such as may be accessible by various customers. In yet some cases, when a customer created a new workflow, the workflow may in some cases be generalized, and then added to the library, to aid in the proliferations of capabilities within the platform. In some aspects, various workflows may be broken into blocks and a graphical user interface provided that enables selection. And combination of different workflow blocks or templates, to more readily enable creation of new more complex workflows.

Another feature provided by system 1200 may include a file processor, which may provide the ability to process files containing sensitive data without needing to touch that underlying data on a customer server. This feature may provide the ability to decrypt a file using a private key, assuming the file was encrypted with the public key, chunk that file into smaller sets of data, process all of those chunks of data with a reactor, and then thread those chunks back together into the original file and send it to a new destination for a non-PCI compliant service to pick up. In some cases, a customer, using this feature, may cause an encrypted file to be manipulated.

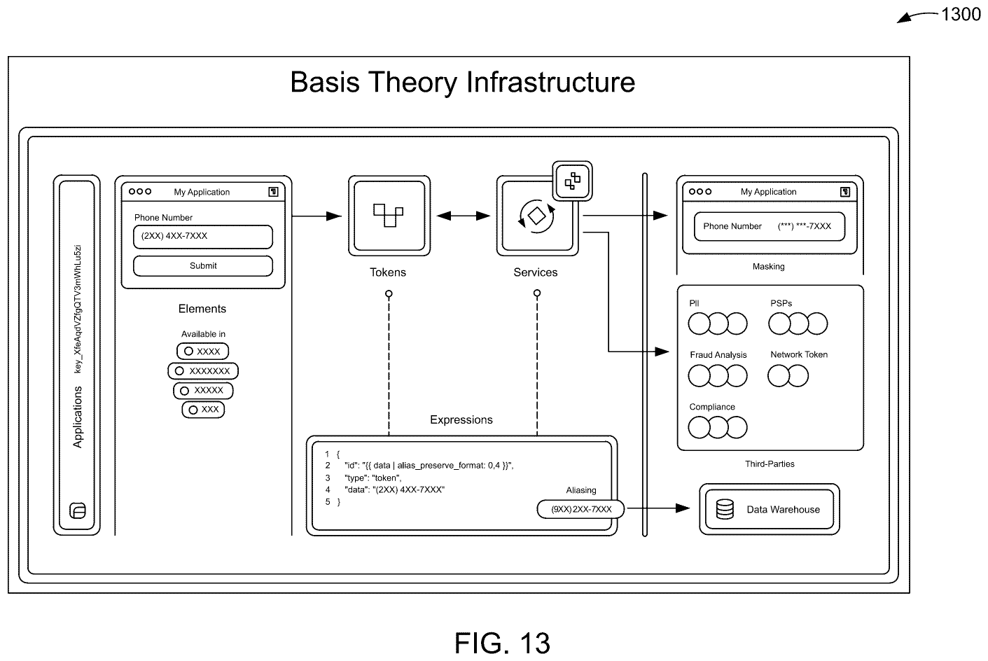

FIG. 13 illustrates an example of interactions with a tokenized data system 1300, such as may be an example of system 1200 described above in reference to FIG. 12. As illustrated in the example of FIG. 13, a customer application (e.g., web, mobile, etc.) may provide for an input, which may be provided by one or more configured elements 1222, to obtain a user's phone number. The tokenized data system may ingest the phone number via the element, and using a configured expression, such as an expression 1220, may generate a token for the data. As illustrated, a token ID ((962) 285-7890) may be generated and stored in a data warehouse (e.g., which may be an example of the vault database 1208). In this example, the token ID may take the form of an alias (e.g., simulating an actual phone number, such as to adhere to data requirements of other processes of applications when ingesting and using that data. The token/alias may then be used by various services, in place of the actual phone number, to store, modify, and transfer the data between different endpoints, within the system or to customer applications. In some cases, the actual phone number or token ID may be masked when the data is transmitted or otherwise communicated to an external application or endpoint (e.g., a customer application).

In some aspects, various other use cases may be realized by the described system and techniques. For example, one use case may include utilizing reactors to take images of credit cards, pull the card number directly off of them, tokenize that data, and send the token to a service. Another use case may include the ability to capture credit cards over a phone call via Twilio. Another use case may include creating/generating an auth0 template utilizing react to make it much easier to manage than pure html. Another use case includes providing payment orchestration inside of reactors. In this example, a customer needs to charge their end-user's credit card. The customer may invoke a reactor with a token contain this card, and inside of this reactor the custom could define where to route this credit card number. Another use case is the ability for payment orchestration to be created inside of a customer's own code base without becoming PCI compliant by utilizing proxies and reactors together. Another use case is the ability to store end-user credentials that are needed by customer's to do their jobs. For example, if a service offered the ability to manage a stripe account, the customer they would need access to the stripe credentials. The customer could then store those credentials with basis theory.Findex.

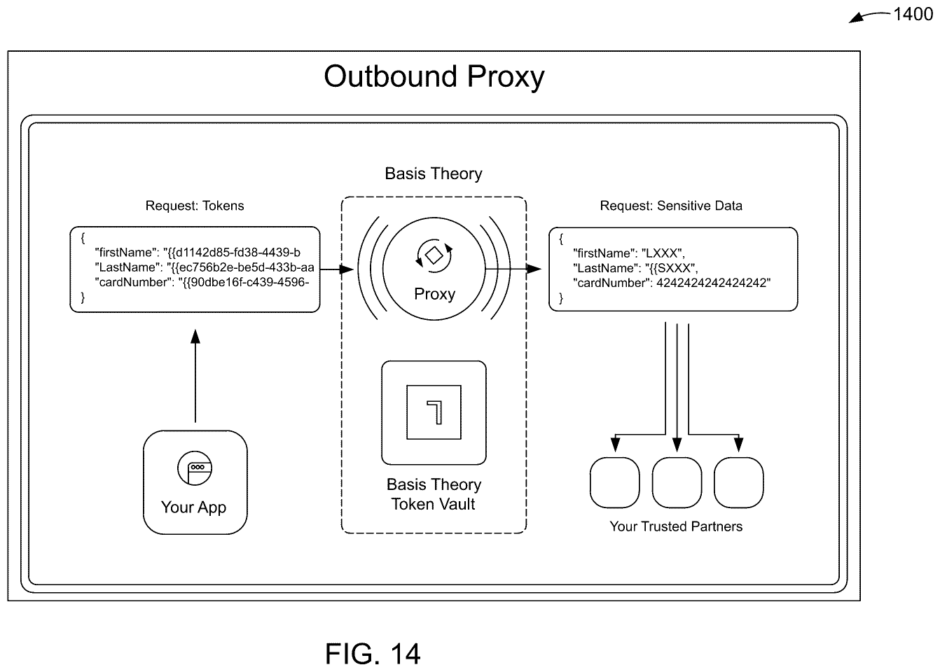

FIG. 14 illustrates an example of an outbound proxy, such as may be an example of proxy 1216 described above in reference to FIG. 12. In some examples, outbound HTTP requests initiated from a customer system can include tokens within the request payload. The proxy can detokenize and substitute the token data into the request before forwarding it to the desired destination. This makes it easy to share sensitive data with a third party without needing to first retrieve and manipulate this sensitive data on your servers. In some cases, a customer system initiates an outbound HTTP request to an ephemeral proxy or a pre-configured proxy instance hosted by the tokenized data system. To include sensitive data in the request, token identifiers can be included within expressions included in the request. These are patterns of the form {{<tokenId>}}, where <tokenId> is the id of a token created within a system tenant or account. The request is transformed by evaluating each expression and substituting the resulting plaintext values within the request. Finally, the transformed request containing sensitive data is delivered to the configured destination URL. The proxy may terminate the inbound TLS connection from the customer servers and initiate a new TLS connection to the destination in order to guarantee secure transmission of the sensitive token data. Whatever the content type or HTTP method, any HTTP request can be sent through the proxy.

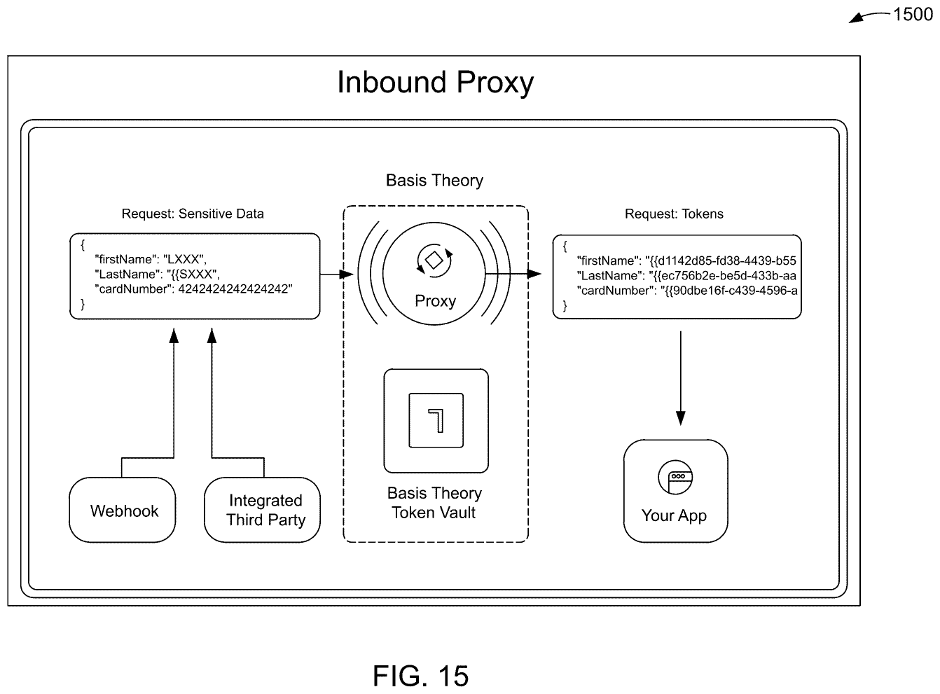

FIG. 15 illustrates an example of an inbound proxy, such as may be an example of proxy 1216 described above in reference to FIG. 12. In some examples, third parties that integrate into customer systems by calling an HTTP API may include sensitive data within their requests. Inbound HTTP requests into a customer system can be routed through the proxy to parse and tokenize sensitive pieces of data and substitute non-sensitive token identifiers into the request payload before it reaches outside servers. In some cases, a proxy instance may be configured, which provides a unique URL to this proxy that can be shared with a third party integrator. The third party can then make HTTP requests to this URL that pass through the proxy before being forwarded on to the customer system. In some cases, the proxy instance can be configured with a request transform containing custom Node.js code that will execute within the proxy before the request is forwarded to customer servers/endpoints. This allows parsing of the request and tokenizing sensitive data fields within the payload, substituting in non-sensitive tokens into the request. The endpoint will receive a request containing the non-sensitive token identifiers that can be safely stored in the customer system.

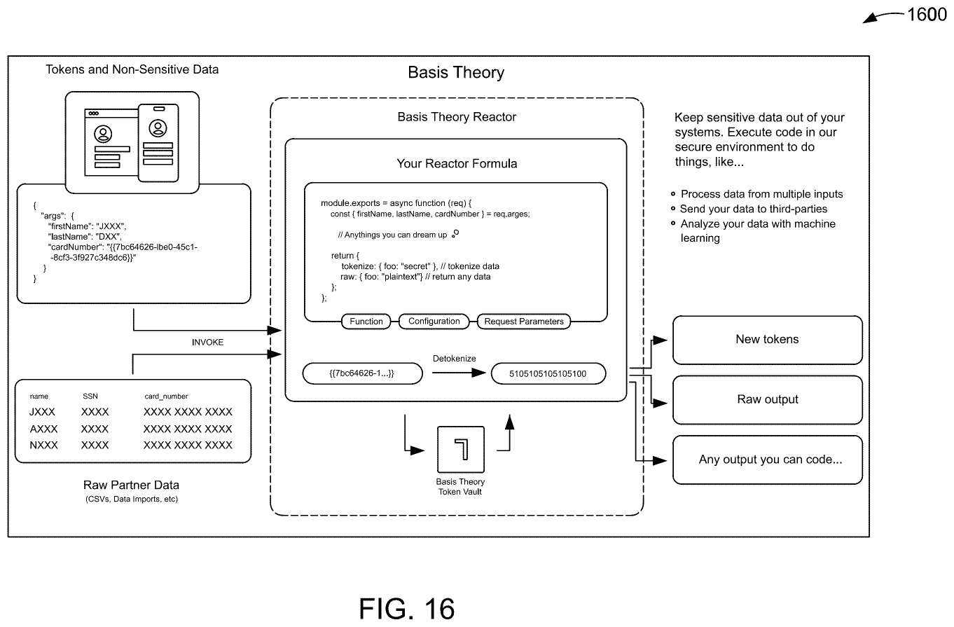

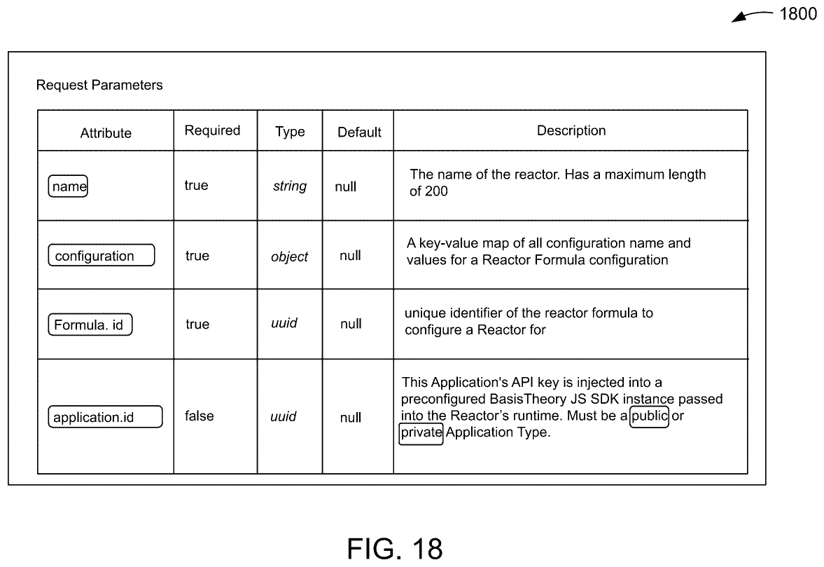

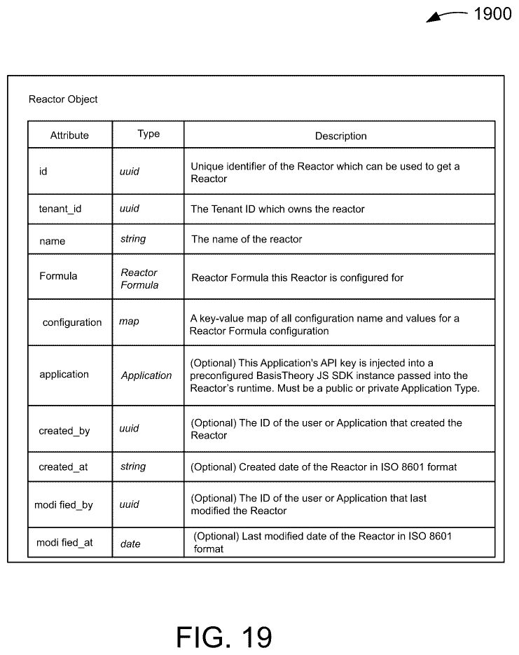

FIG. 16 illustrates example interactions 1600 with a reactor, such as may be an example of reactor 1218 described above in reference to FIG. 12. In some examples, using a reactor starts with the code or instructions to execute; this code block may referred to as a reactor formula. To create a reactor formula, the following attributes may be defined: the code, expected request parameters, and any up-front configuration, such as secrets required to execute a function. In some cases, a reactor formula may support two different response types, giving the flexibility to either securely tokenize sensitive outputs or to return raw outputs in the response: tokenize, such that any object passed will be tokenized; and raw, such that any object passed will be returned from the HTTP request that invoked the reactor. In some cases, a library of pre-defined reactor formulas may be provided, maintained, and/or generated by the system for common integration scenarios. FIG. 18 illustrates an n example API data structure for creating a reactor. FIG. 19 illustrates an example reactor data object, which may define attributes of an example reactor. It should be appreciated that various implementations of reactors may include some or all of the attributes illustrated in FIG. 8, and may take similar or different forms for various attributes or fields.

Creating a Reactor: Reactors may be created with a create reactor endpoint. Once configured, each reactor can be invoked, such that it executes the formula it has been configured with. In some cases, creating a new reactor may include passing in the configuration and formula to be invoked. Here is an example of instructions to create a reactor:

```
curl “https://api.basistheory.com/reactors” \
  -H “BT-API-KEY: <API_KEY_HERE>” \
  -H “Content-Type: application/json” \
  -X “POST” \
  -d ‘{
    “name”: “My First Reactor”,
    “configuration”: {
      “SERVICE_API_KEY”: “key_abcd1234”
    },
    “formula”: {
      “id”: “17069df1-80f4-439e-86a7-4121863e4678”
    }
  }’
```

In some cases, each configuration setting for a reactor may be stored securely for future access, such as in a secure PCI Level 1 and SOC2 environment (e.g., vault database 1208).

Invoking a Reactor: Any reactor can be invoked either synchronously or asynchronously depending on the parameters provided within the request. In some cases, reactors may be invoked by any private application with token: use permission, which enables the reactor to detokenize tokens provided in the request args. It may be recommended, in some cases, to restrict which tokens a reactor can detokenize by only granting token: use permission on the most-specific container of tokens that is required.

Synchronous Reactors: In some cases, reactors are invoked synchronously by default, unless a callback_url is specified in the request. In some aspects, synchronous reactors may be limited to a default or configurable execution time (e.g., 10 seconds) before they are terminated. If a reactor workload will take longer than this limit, asynchronous reactors may be used instead. Here is an example of instructions to create a synchronous reactor:

```
curl“https://api.basistheory.com/reactors/5b493235-6917-4307-906a-
2cd6f1a90b13/react” \
  -H “BT-API-KEY: key_N88mVGsp3sCXkykyN2EFED” \
  -X “POST” \
  -d ‘{
    “args”: {
      “card”: “{{fe7c0a36-eb45-4f68-b0a0-791de28b29e4}}”,
      “customer_id”: “myCustomerId1234”
    }
  }’
```

Asynchronous Reactors: Reactors are invoked asynchronously by providing a callback_url parameter within the request. In these examples, the reactor will perform some synchronous validation to ensure the request is valid, then immediately respond with an empty HTTP response with 202 Accepted status code. The reactor code may then be asynchronously executed in our serverless compute environment for up to the configured timeout specified in the timeout_ms parameter. If not specified, this value may default to 10000 (i.e. 10 seconds), or any other configurable amount. In some cases, if the timeout period is exceeded, the reactor will be terminated and a callback containing a reactor runtime error indicating that a timeout occurred may be generated. Once the reactor is completed, the response from the reactor code may be delivered in the body of an HTTP POST request to the specified callback_url. In some cases, the callback endpoint may be hosted using HTTPS, and may be prompted to respond with a 2xx status code after receiving the message. In some cases, if the servers fail to respond with a 2xx status code, delivery will retried up to 10 times with exponential backoff over the next ˜2.5 hours. Any errors that occur while executing the reactor may be delivered to the callback_url to enable correction and analysis. Here is an example of instructions to create an asynchronous reactor:

```
  curl“https://api.basistheory.com/reactors/5b493235-6917-4307-906a-
  2cd6f1a90b13/react” \
    -H “BT-API-KEY: key_N88mVGsp3sCXkykyN2EFED” \
    -X “POST” \
    -d ‘{
      “args”: {
        “card”: “{{fe7c0a36-eb45-4f68-b0a0-791de28b29e4}}”,
        “customer_id”: “myCustomerId1234”
      },
      “callback_url”: “https://my-service.com/webhooks/transactions/b1d16efc-f613-45af-
  a1d5-57b07ddd741b”,
      “timeout_ms”: 60000
}’
```

Now will be described some common use cases for reactors. It should be appreciated that the following description is only, exemplary, and that carious other formulas, reactors, and processes are contemplated herein.

Call a 3^{rd} party: Depending on how complex the use case is, a reactor may provide capabilities to mutate data before forwarding it onto a 3^{rd} party endpoint. In the below example, a service, such as an echo service (e.g., httpbin.org) may be called with the last 4 characters of a token:

```
module.exports = async function (req) {
  const fetch = require(“node-fetch”);
  const { customer_id } = req.args;
  const last4 = customer_id.substring(−4);
  const response = await fetch(“https://httpbin.org/post”, {
    method: “POST”,
    body: last4,
  });
  const raw = await resp.json( );
  return {
    raw,
  };
};
```

Create a pdf document: Creating documents out of sensitive data is a primary need for businesses today, especially in fintech where there is a need to create and submit 1099s for many businesses:

```
module.exports = async function (req) {
  const fetch = require(“node-fetch”);
  const PDFDocument = require(“pdfkit”);
  const {
    token: { data },
  } = req.args;
  let doc = new PDFDocument( );
  doc.fontSize(8).text(‘Some token data on a pdf: ${ data}‘, 1, 1);
  doc.end( );
  //Send or upload file to your partner
  const response = await fetch(“https://httpbin.org/post”, {
    method: “POST”,
    body: doc,
  });
  const raw = await resp.json( );
  return {
    raw,
  };
};
```

Generate a text file and send to an SFTP server: Many legacy business process still rely heavily on comma delimited files (CSV), tab delimited files or space-delimited files to transport data between companies, typically using SFTP servers as the endpoint of this data. For example, engaging with partner banks with ACH files requires formatting a file correctly and dropping it on to an SFTP server. Here is an example of instructions to format a file:

```
module.exports = async function (req) {
  var fs = require(“fs”);
  var {Client} = require(′ssh2′);
  const { token: { { prop1, prop2, prop3 } } } = req.args;
  const { host, username, password } = req.configuration;
  var connSettings = { host, port: 22, username, password };
  var conn = new Client( );
  return new Promise((resolve) =>
    conn.on(′ready′, function( ) {
      conn.sftp(function(err, sftp) {
        var bufferStream = new require(′stream′).PassThrough( );
        bufferStream.end(Buffer.from(‘${prop1},${prop2},${prop3}‘,
        “utf-8”));
        const writeStream = sftp.createWriteStream( “test.csv”);
        writeStream.on(′close′,function( ) {
          res.json({success: true});
          resolve( );
        });
        bufferStream.pipe(writeStream);
      });
    }).connect(connSettings));
  };
```

Import file from a partner: When there is a need to process files of sensitive data without the data being exposed to other systems, a reactor can be utilized to desensitize a file before forwarding it on to other systems:

```
module.exports = async function (req) {
  const { BasisTheory } = require(“@basis-theory/basis-theory-js”);
  const { fileString } = req.args; // “name,ssn\nTheory,555445555”
  const { BT_API_KEY } = req.configuration;
  const bt = await new BasisTheory( ).init(BT_API_KEY);
  const rows = fileString.split(“\n”).map((r) => r.split(“,”));
  await Promise.all(
    rows.slice(1).map((row) => {
      return bt.tokens
        .create({
          type: “social_security_number”,
          data: row[1],
        })
        .then((token) => (row[1] = token.id));
    })
  );
  const desensitizedFile = rows.map((row) => row.join(“,”)).join(“\n”);
  res.json({ raw: desensitizedFile }); // “name,ssn\nTheory,14f5c8d4-3e84-4185-96ac-
fac6386614dc”
};
```

Various other functions and operations: the structure of the reactors enables customization of just about any operation, transformation or transferring of data. The high level input/output operations may start with the following:

```
  module.exports = async function (req) {
    const { tokens } = req.args;
    // Anything you can dream up [symbol]
    return {
      tokenize: { foo: “bar” }, // tokenize data
      raw: { foo: “bar” }, // return any data
    };
};
```

In various examples, the described systems and techniques may include one or more of the following features.

A computer-implemented method for processing a transaction comprising one or more transfers of sensitive data using a universal token in a transaction orchestration system, the method comprising one or more of: generating a universal token representative of sensitive data received from a first device, the universal token comprising one or more aliased data sets and metadata corresponding to the underlying sensitive data stored in one or more of a centralized vault or secondary storage, wherein the one or more aliased data sets include representations of the sensitive data without including the sensitive data; receiving, by an a transaction request that invokes the universal token, the transaction request including data that directly or indirectly identifies the universal token, the request specifying one or more transaction attributes; retrieving an aliased data set of the one or more aliased datasets from the universal token, wherein the aliased data set corresponds to the sensitive data to fulfill the transaction; routing the transaction request to a processing service of a plurality of processing services according to one or more pre-configured connection contracts, the routing to the processing service of the plurality of processing services determined based on the one or more transaction attributes and predefined ruleset; transmitting the aliased data to the selected processing service to complete the transaction; and responsive to receiving a transaction response from the selected processing service, generating a notification of transaction completion.

In some cases, the computer implemented method described above may additionally or alternatively include responsive to receiving modified sensitive data, determining that the modified sensitive data corresponds to the sensitive data; and updating the universal token based on the modified sensitive data. In some cases, the computer implemented method described above may additionally or alternatively include selecting one of the centralized vault or the secondary storage to store the updated universal token based on whether there is a network connection to the centralized vault. In some cases, the computer implemented method described above may additionally or alternatively include responsive to receiving a first aliased data set, determining that the first aliased data set references the sensitive data; and update the universal token to include the first aliased data set. In some cases, the computer implemented method described above may additionally or alternatively include selecting one of the centralized vault or the secondary storage to store the updated universal token based on detecting whether there is a network connection to the centralized vault. In some cases, the computer implemented method described above may additionally or alternatively include updating the universal token to include the first aliased data set in an isolated execution environment. In some cases, the computer implemented method described above may additionally or alternatively include generating one or more search indexes based on the sensitive data and the universal token, wherein the one or more search indexes do not include the sensitive data.

A data transaction system, comprising: one or more processors; and memory that stores computer-executable instructions that, if executed, cause the one or more processors to: obtain sensitive data from a first device; generate and store a universal token representative of the sensitive data, the universal token comprising one or more aliased data sets and metadata corresponding to the underlying sensitive data, wherein the one or more aliased data sets include representations of the sensitive data without including the sensitive data; receive a transaction request that invokes the universal token, the transaction request including data that directly or indirectly identifies the universal token, the request specifying one or more transaction attributes; retrieve an aliased data set of the one or more aliased datasets from the universal token, wherein the aliased data set corresponds to the sensitive data to fulfill the transaction; route the transaction request to a processing service of a plurality of processing services according to one or more pre-configured connection contracts, the routing to the processing service of the plurality of processing services determined based on the one or more transaction attributes; and transmit the aliased data to the selected processing service to complete the transaction.

In some cases, the memory of the system described above stores additional computer-executable instructions that, if executed, cause the one or more processors to: determine whether a network connection to a centralized vault is active; and based on determining that a network connection to the central vault is active, cause the universal token to be stored in the centralized vault. In some cases, the memory of the system described above stores additional computer-executable instructions that, if executed, cause the one or more processors to: determine whether a network connection to a centralized vault is active; and based on determining that a network connection to the central vault is not active, cause the universal token to be stored in a secondary storage location having an active network connection. In some cases, the memory of the system described above stores additional computer-executable instructions that, if executed, cause the one or more processors to: responsive to receiving modified sensitive data, determine that the modified sensitive data corresponds to the sensitive data; and update the universal token based on the modified sensitive data. In some cases, the memory of the system described above stores additional computer-executable instructions that, if executed, cause the one or more processors to: select one of a centralized vault or a secondary storage to store the updated universal token based on whether a network connection to the centralized vault is detected. In some cases, the memory of the system described above stores additional computer-executable instructions that, if executed, cause the one or more processors to: update the universal token to include the first aliased data set in an isolated execution environment.

In some cases, the memory of the system described above stores additional computer-executable instructions that, if executed, cause the one or more processors to: modify the universal token by adding or changing data contained within the universal token, wherein the modifying is performed in an isolated execution environment. In some cases, the memory of system described above stores additional computer-executable instructions that, if executed, cause the one or more processors to: determine that a first universal token and a second universal token reference the same identity; and based on the determining, combine the first universal token and the second universal token in an isolated execution environment to generate a combined universal token. In some cases, the memory of the system described above stores additional computer-executable instructions that, if executed, cause the one or more processors to: generate one or more search indexes based on the sensitive data and the universal token, wherein the one or more search indexes do not include the sensitive data.

A non-transitory computer-readable storage medium storing thereon executable instructions that, as a result of being executed by one or more processors of a computer system, cause the computer system to at least: generate, by a universal token coordinator, a universal token representative of sensitive data received from a first device, the universal token comprising one or more aliased data sets and metadata corresponding to the underlying sensitive data stored in one or more of a centralized vault or secondary storage, wherein the one or more aliased data sets include representations of the sensitive data without including the sensitive data; receive a transaction request that invokes the universal token, the transaction request including data that directly or indirectly identifies the universal token, the request specifying one or more transaction attributes; retrieve an aliased data set of the one or more aliased datasets from the universal token, wherein the aliased data set corresponds to the sensitive data to fulfill the transaction; route the transaction request to a processing service of a plurality of processing services according to one or more pre-configured connection contracts, the routing to the processing service of the plurality of processing services determined based on the one or more transaction attributes and predefined ruleset; and transmit the aliased data to the selected processing service to complete the transaction.

In some cases, the non-transitory computer-readable storage medium described above stores additional instructions that cause the computer system to: responsive to receiving modified sensitive data, determine that the modified sensitive data corresponds to the sensitive data; and update the universal token based on the modified sensitive data in a isolated execution environment In some cases, the non-transitory computer-readable storage medium described above stores additional instructions that cause the computer system to: select one of the centralized vault or the secondary storage to store the updated universal token based on whether there is a network connection to the centralized vault. In some cases, the non-transitory computer-readable storage medium described above stores additional instructions that cause the computer system to: responsive to receiving a first aliased data set, determine that the first aliased data set references the sensitive data; and update the universal token to include the first aliased data set in an isolated execution environment.

The various embodiments further can be implemented in a wide variety of operating environments, which in some cases can include one or more user computers, computing devices or processing devices that can be used to operate any of a number of applications. In an embodiment, user or client devices include any of a number of computers, such as desktop, laptop or tablet computers running a standard operating system, as well as cellular (mobile), wireless and handheld devices running mobile software and capable of supporting a number of networking and messaging protocols, and such a system also includes a number of workstations running any of a variety of commercially available operating systems and other known applications for purposes such as development and database management. In an embodiment, these devices also include other electronic devices, such as dummy terminals, thin-clients, gaming systems and other devices capable of communicating via a network, and virtual devices such as virtual machines, hypervisors, software containers utilizing operating-system level virtualization and other virtual devices or non-virtual devices supporting virtualization capable of communicating via a network.

In an embodiment, a system utilizes at least one network that would be familiar to those skilled in the art for supporting communications using any of a variety of commercially available protocols, such as Transmission Control Protocol/Internet Protocol (“TCP/IP”), User Datagram Protocol (“UDP”), protocols operating in various layers of the Open System Interconnection (“OSI”) model, File Transfer Protocol (“FTP”), Universal Plug and Play (“UpnP”), Network File System (“NFS”), Common Internet File System (“CIFS”) and other protocols. The network, in an embodiment, is a local area network, a wide-area network, a virtual private network, the Internet, an intranet, an extranet, a public switched telephone network, an infrared network, a wireless network, a satellite network, and any combination thereof. In an embodiment, a connection-oriented protocol is used to communicate between network endpoints such that the connection-oriented protocol (sometimes called a connection-based protocol) is capable of transmitting data in an ordered stream. In an embodiment, a connection-oriented protocol can be reliable or unreliable. For example, the TCP protocol is a reliable connection-oriented protocol. Asynchronous Transfer Mode (“ATM”) and Frame Relay are unreliable connection-oriented protocols. Connection-oriented protocols are in contrast to packet-oriented protocols such as UDP that transmit packets without a guaranteed ordering.

In an embodiment, the system utilizes a web server that runs one or more of a variety of server or mid-tier applications, including Hypertext Transfer Protocol (“HTTP”) servers, FTP servers, Common Gateway Interface (“CGI”) servers, data servers, Java servers, Apache servers, and business application servers. In an embodiment, the one or more servers are also capable of executing programs or scripts in response to requests from user devices, such as by executing one or more web applications that are implemented as one or more scripts or programs written in any programming language, such as Java®, C, C# or C++, or any scripting language, such as Ruby, PHP, Perl, Python or TCL, as well as combinations thereof. In an embodiment, the one or more servers also include database servers, including without limitation those commercially available from Oracle®, Microsoft®, Sybase®, and IBM® as well as open-source servers such as MySQL, Postgres, SQLite, MongoDB, and any other server capable of storing, retrieving, and accessing structured or unstructured data. In an embodiment, a database server includes table-based servers, document-based servers, unstructured servers, relational servers, non-relational servers, or combinations of these and/or other database servers.

In an embodiment, the system includes a variety of data stores and other memory and storage media as discussed above that can reside in a variety of locations, such as on a storage medium local to (and/or resident in) one or more of the computers or remote from any or all of the computers across the network. In an embodiment, the information resides in a storage-area network (“SAN”) familiar to those skilled in the art and, similarly, any necessary files for performing the functions attributed to the computers, servers or other network devices are stored locally and/or remotely, as appropriate. In an embodiment where a system includes computerized devices, each such device can include hardware elements that are electrically coupled via a bus, the elements including, for example, at least one central processing unit (“CPU” or “processor”), at least one input device (e.g., a mouse, keyboard, controller, touch screen, or keypad), at least one output device (e.g., a display device, printer, or speaker), at least one storage device such as disk drives, optical storage devices, and solid-state storage devices such as random access memory (“RAM”) or read-only memory (“ROM”), as well as removable media devices, memory cards, flash cards, etc., and various combinations thereof.

In an embodiment, such a device also includes a computer-readable storage media reader, a communications device (e.g., a modem, a network card (wireless or wired), an infrared communication device, etc.), and working memory as described above where the computer-readable storage media reader is connected with, or configured to receive, a computer-readable storage medium, representing remote, local, fixed, and/or removable storage devices as well as storage media for temporarily and/or more permanently containing, storing, transmitting, and retrieving computer-readable information. In an embodiment, the system and various devices also typically include a number of software applications, modules, services, or other elements located within at least one working memory device, including an operating system and application programs, such as a client application or web browser. In an embodiment, customized hardware is used and/or particular elements are implemented in hardware, software (including portable software, such as applets), or both. In an embodiment, connections to other computing devices such as network input/output devices are employed.

In an embodiment, storage media and computer readable media for containing code, or portions of code, include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by the system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions, and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. Similarly, use of the term “or” is to be construed to mean “and/or” unless contradicted explicitly or by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood within the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context. In addition, unless otherwise noted or contradicted by context, the term “plurality” indicates a state of being plural (e.g., “a plurality of items” indicates multiple items). The number of items in a plurality is at least two but can be more when so indicated either explicitly or by context.

Operations of processes described herein can be performed in any suitable order unless otherwise indicated herein or otherwise clearly contradicted by context. In an embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In an embodiment, the code is stored on a computer-readable storage medium, for example, in the form of a computer program comprising a plurality of instructions executable by one or more processors. In an embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In an embodiment, code (e.g., executable code or source code) is stored on a set of one or more non-transitory computer-readable storage media having stored thereon executable instructions that, when executed (i.e., as a result of being executed) by one or more processors of a computer system, cause the computer system to perform operations described herein. The set of non-transitory computer-readable storage media, in an embodiment, comprises multiple non-transitory computer-readable storage media, and one or more of individual non-transitory storage media of the multiple non-transitory computer-readable storage media lack all of the code while the multiple non-transitory computer-readable storage media collectively store all of the code. In an embodiment, the executable instructions are executed such that different instructions are executed by different processors—for example, in an embodiment, a non-transitory computer-readable storage medium stores instructions and a main CPU executes some of the instructions while a graphics processor unit executes other instructions. In another embodiment, different components of a computer system have separate processors and different processors execute different subsets of the instructions.

Accordingly, in an embodiment, computer systems are configured to implement one or more services that singly or collectively perform operations of processes described herein, and such computer systems are configured with applicable hardware and/or software that enable the performance of the operations. Further, a computer system, in an embodiment of the present disclosure, is a single device and, in another embodiment, is a distributed computer system comprising multiple devices that operate differently such that the distributed computer system performs the operations described herein and such that a single device does not perform all operations.

The use of any and all examples or exemplary language (e.g., “such as”) provided herein is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references including publications, patent applications, and patents cited herein are hereby incorporated by reference to the same extent as if each reference were individually and specifically indicated to be incorporated by reference and were set forth in its entirety herein.

What is claimed is:

1. A computer-implemented method for processing a transaction comprising one or more transfers of sensitive data using a universal token in a transaction orchestration system, the method comprising:
generating a universal token representative of sensitive data received from a first device, the universal token comprising one or more aliased data sets and metadata corresponding to the underlying sensitive data stored in one or more of a centralized vault or secondary storage, wherein the one or more aliased data sets include representations of the sensitive data without including the sensitive data;
receiving, by a transaction request that invokes the universal token, the transaction request including data that directly or indirectly identifies the universal token, the request specifying one or more transaction attributes;
retrieving an aliased data set of the one or more aliased datasets from the universal token, wherein the aliased data set corresponds to the sensitive data to fulfill the transaction;
routing the transaction request to a processing service of a plurality of processing services according to one or more pre-configured connection contracts, the routing to the processing service of the plurality of processing services determined based on the one or more transaction attributes and predefined ruleset;
transmitting the aliased data to the selected processing service to complete the transaction; and
responsive to receiving a transaction response from the selected processing service, generating a notification of transaction completion.

2. The computer-implemented method of claim 1, further comprising:
responsive to receiving modified sensitive data, determining that the modified sensitive data corresponds to the sensitive data; and
updating the universal token based on the modified sensitive data.

3. The computer-implemented method of claim 2, further comprising:
selecting one of the centralized vault or the secondary storage to store the updated universal token based on whether there is a network connection to the centralized vault.

4. The computer-implemented method of claim 1, further comprising:
responsive to receiving a first aliased data set, determining that the first aliased data set references the sensitive data; and
update the universal token to include the first aliased data set.

5. The computer-implemented method of claim 2, further comprising:
selecting one of the centralized vault or the secondary storage to store the updated universal token based on detecting whether there is a network connection to the centralized vault.

6. The computer-implemented method of claim 2, wherein updating the universal token to include the first aliased data set is performed in an isolated execution environment.

7. The computer-implemented method of claim 1, further comprising:
generating one or more search indexes based on the sensitive data and the universal token, wherein the one or more search indexes do not include the sensitive data.

8. A data transaction system, comprising:
one or more processors; and
memory that stores computer-executable instructions that, if executed, cause the one or more processors to:
obtain sensitive data from a first device;
generate and store a universal token representative of the sensitive data, the universal token comprising one or more aliased data sets and metadata corresponding to the underlying sensitive data, wherein the one or more aliased data sets include representations of the sensitive data without including the sensitive data;
receive a transaction request that invokes the universal token, the transaction request including data that directly or indirectly identifies the universal token, the request specifying one or more transaction attributes;
retrieve an aliased data set of the one or more aliased datasets from the universal token, wherein the aliased data set corresponds to the sensitive data to fulfill the transaction;
route the transaction request to a processing service of a plurality of processing services according to one or more pre-configured connection contracts, the routing to the processing service of the plurality of processing services determined based on the one or more transaction attributes; and
transmit the aliased data to the selected processing service to complete the transaction.

9. The system of claim 8, wherein the memory stores additional computer-executable instructions that, if executed, cause the one or more processors to:
determine whether a network connection to a centralized vault is active;
based on determining that a network connection to the central vault is active, cause the universal token to be stored in the centralized vault.

10. The system of claim 9, wherein the memory stores additional computer-executable instructions that, if executed, cause the one or more processors to:
determine whether a network connection to a centralized vault is active;
based on determining that a network connection to the central vault is not active, cause the universal token to be stored in a secondary storage location having an active network connection.

11. The system of claim 8, wherein the memory stores additional computer-executable instructions that, if executed, cause the one or more processors to:
responsive to receiving modified sensitive data, determine that the modified sensitive data corresponds to the sensitive data; and
update the universal token based on the modified sensitive data.

12. The system of claim 11, wherein the memory stores additional computer-executable instructions that, if executed, cause the one or more processors to:
select one of a centralized vault or a secondary storage to store the updated universal token based on whether a network connection to the centralized vault is detected.

13. The system of claim 11, wherein updating the universal token to include the first aliased data set is performed in an isolated execution environment.

14. The system of claim 8, wherein the memory stores additional computer-executable instructions that, if executed, cause the one or more processors to:
modify the universal token by adding or changing data contained within the universal token, wherein the modifying is performed in an isolated execution environment.

15. The system of claim 8, wherein the memory stores additional computer-executable instructions that, if executed, cause the one or more processors to:
determine that a first universal token and a second universal token reference the same identity;
based on the determining, combine the first universal token and the second universal token in an isolated execution environment to generate a combined universal token.

16. The system of claim 8, wherein the memory stores additional computer-executable instructions that, if executed, cause the one or more processors to:
generate one or more search indexes based on the sensitive data and the universal token, wherein the one or more search indexes do not include the sensitive data.

17. A non-transitory computer-readable storage medium storing thereon executable instructions that, as a result of being executed by one or more processors of a computer system, cause the computer system to at least:
generate, by a universal token coordinator, a universal token representative of sensitive data received from a first device, the universal token comprising one or more aliased data sets and metadata corresponding to the underlying sensitive data stored in one or more of a centralized vault or secondary storage, wherein the one or more aliased data sets include representations of the sensitive data without including the sensitive data;
receive a transaction request that invokes the universal token, the transaction request including data that directly or indirectly identifies the universal token, the request specifying one or more transaction attributes;
retrieve an aliased data set of the one or more aliased datasets from the universal token, wherein the aliased data set corresponds to the sensitive data to fulfill the transaction;
route the transaction request to a processing service of a plurality of processing services according to one or more pre-configured connection contracts, the routing to the processing service of the plurality of processing services determined based on the one or more transaction attributes and predefined ruleset; and
transmit the aliased data to the selected processing service to complete the transaction.

18. The non-transitory computer-readable storage medium of claim 17, wherein the instructions further comprise additional instructions, that cause the computer system to:
responsive to receiving modified sensitive data, determine that the modified sensitive data corresponds to the sensitive data; and
update the universal token based on the modified sensitive data in a isolated execution environment.

19. The non-transitory computer-readable storage medium of claim 17, wherein the instructions further comprise additional instructions, that cause the computer system to:
select one of the centralized vault or the secondary storage to store the updated universal token based on whether there is a network connection to the centralized vault.

20. The non-transitory computer-readable storage medium of claim 17, wherein the instructions further comprise additional instructions, that cause the computer system to:
responsive to receiving a first aliased data set, determine that the first aliased data set references the sensitive data; and
update the universal token to include the first aliased data set in an isolated execution environment.
